(19) United States
(12) Patent Application Publication
(10) Pub. No.: US 2018/0374052 A1
(43) Pub. Date: Dec. 27, 2018

(54) METHOD OF IMPROVIDING BUILDING INFORMATION MODELING

(71) Applicant: Chetan Mogal, Leesburg, VA (US)

(72) Inventor: Chetan Mogal, Leesburg, VA (US)

(21) Appl. No.: 15/848,755

(22) Filed: Dec. 20, 2017

Related U.S. Application Data
(60) Provisional application No. 62/436,761, filed on Dec. 20, 2016.

(51) Int. Cl. G06Q 10/10; G06Q 10/06; G06F 17/50; G06Q 50/08; G06T 17/05

(52) U.S. Cl. CPC G06Q 10/103; G06Q 10/063114; G06T 2210/04; G06Q 50/08; G06T 17/05; G06F 17/5004

(57) ABSTRACT

A method for improving a building information modeling system for a construction project is provided. The method couples a field reporting functionality to the building modeling system; the field reporting functionality adapted to: obtain virtual project data relating to the building modeling system, wherein project data is associated with resolution of a task of the building modeling system; provide a schedule modality configured to a first timeline for both a delivery of the project data and a second timeline for an associated resolution to the project data; and provide a progress modality configured to link field data from a jobsite of the construction project to the project data.

### CROSS-REFERENCE TO RELATED APPLICATION

This application claims the benefit of priority of U.S. provisional application No. 62/436,761, filed 20 Dec. 2016, the contents of which are herein incorporated by reference.

### BACKGROUND OF THE INVENTION

The present invention can be applied to broader industry but currently relates to Building Information Modeling (BIM) and, more particularly, applies to a method and system for improving BIM workflow through integrating BIM project data with field data and communication data. BIM is can be improved through the tracking and collecting of field data and communication data and its integration with BIM data for procurement, field and project management. Moreover, the present invention enables automated analytics for improving jobsite and overall construction project management, specifically by systematically integrating BIM data, field data, project management data, pertaining communication.

Currently, project management involves isolated data points, hardcopies filed by hand, wherein typed forms are the basic or only point of data entry, and relying on non-integrated communication between the many parties involved in these complex projects, making data integration time consuming and fraught with human error.

Being a digital representation of physical and functional characteristics of a facility, BIM is a shared knowledge resource for information about a facility, forming a reliable basis for decisions during the building's life-cycle. BIM is used by individuals, businesses and government agencies who plan, design, construct, operate and maintain diverse physical infrastructures, such as water, refuse, electricity, gas, communication utilities, roads, bridges, ports, tunnels, etc. In general, any user of a BIM application may create or use BIM content for the generation and management of digital representations of the physical and functional characteristics of structures.

Specifically, BIM integrates a plurality of computer models (“BIM models”) from the various stakeholders involved in the design and construction of said structures so that conflicts or “clashes” among the various stakeholders can be identified and managed in the process of delivering the completed structure. Typically, in the construction of a building, BIM integrates the computer models of the architects, the engineers, the plumbing, the mechanical provider, electrician in the like. BIM is configured to generate or represent all the above-mentioned computer models simultaneously, whereby clashes between, say the plumbing components and the fireproofing components, are identified for resolution. Such clashes can be named, grouped by tasks, assigned to more than one of the stakeholders, and tracked from identification, information requests, review and up and through associated resolution.

One of the most important elements for project success is construction productivity (and has been a challenge of the construction industry for decades), which not only requires quick and efficient documentation and information flow from all stakeholders to the field but also the collection, integration, and flow back from the field of the field-related information.

BIM has created some success stories, but the technology envelop remains largely challenged in data gathering, collaborating and integration. BIM tools tend to work in a silo operation in an office environment and also rarely use the cloud platform to integrate the BIM and non-BIM data. Data is irrelevant, unusable or static without understanding the interaction, relation and communication between the data. In the current environment, data is created and retracted in a silo undermining the potential it can bring if integrated in a systematic method. As a result, a disadvantage of current information workflow is the lack of quality data coming back from the field in order to make better day-today operation decision that can guide the projects past the clashes toward and through clash resolution.

As can be seen, there is a need for a method and system for improving BIM management and field integration through tracking, collecting, and integrating jobsite-related data, documenting, integrating the communication and interaction of stakeholders are having regarding the project and field data. The present invention runs fundamentally in a cloud based operation that gathers, scans, analysis and interlinks the BIM and non-BIM data in a three-layered format (virtual, real and in integrated communication) to provide relevant data that is not readily achievable today, but will play a significant role in improving construction productivity, quality and risk management. Specifically, the present invention relates to a three-layered system: 1) project data creation through a virtual process or processes, wherein each project data is part of an associated resolution; 2) systematic interlinking of said project data and field data for tracking, forecasting and managing compliance with each associated resolution, and 3) collection of communication for facilitating the associated resolution through automated tangible analytics, machine learning tools and the like. The present invention embodies the integration of multiple isolated applications that are built of top and within the integrated database.

### SUMMARY OF THE INVENTION

In one aspect of the present invention may be a method for improving a building information modeling system for a construction project including coupling a field reporting functionality to the building modeling system; the field reporting functionality adapted to: obtain virtual project data relating to the building modeling system, wherein project data is associated with resolution of a task of the building modeling system; provide a schedule modality configured to a first timeline for both a delivery of the project data and a second timeline for an associated resolution to the project data; and provide a progress modality configured to link field data from a jobsite of the construction project to the project data.

In another aspect of the present invention may be the method for improving a building information modeling system for a construction project includes coupling a field reporting functionality to the building modeling system; the field reporting functionality adapted to: obtain virtual project data relating to the building modeling system, wherein project data is associated with resolution of a task of the building modeling system, and wherein project data includes at least one asset required for the associated resolution, wherein each asset comprises geometric data and location data, wherein geometric and location data is defined by the information modeling system; provide a schedule modality configured to a first timeline for both a delivery of the project data and a second timeline for an associated resolution to the project data, wherein field data comprises video, audio and textual output linked to the first or second timeline; and provide a progress modality configured to link field data from a jobsite of the construction project to the project data; and a meeting functionality configured to generate communication data linked to the first or second timeline, wherein communication data comprises video or audio output from the jobsite.

These and other features, aspects and advantages of the present invention will become better understood with reference to the following drawings, description, and claims.

### BRIEF DESCRIPTION OF THE DRAWINGS

FIGS. 1 through 14D are flowcharts of exemplary embodiments of the present invention wherein the shapes of the decision boxes have distinct meanings;

FIG. 15 is a flowchart of exemplary embodiments of the present invention; and

FIG. 16 is a flowchart of exemplary embodiments of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

The present invention relates to method of data gathering from various sources, integrating the data and providing analytics that improves data management, data availability, data interaction providing enhanced search results and project management resulting is faster decision making, data and time related forensics. The present invention is cloud-based system combining applications and algorithm, virtual data gathering and management, real data gathering and management and analytics of all such isolated data in a more interlinked data structure.

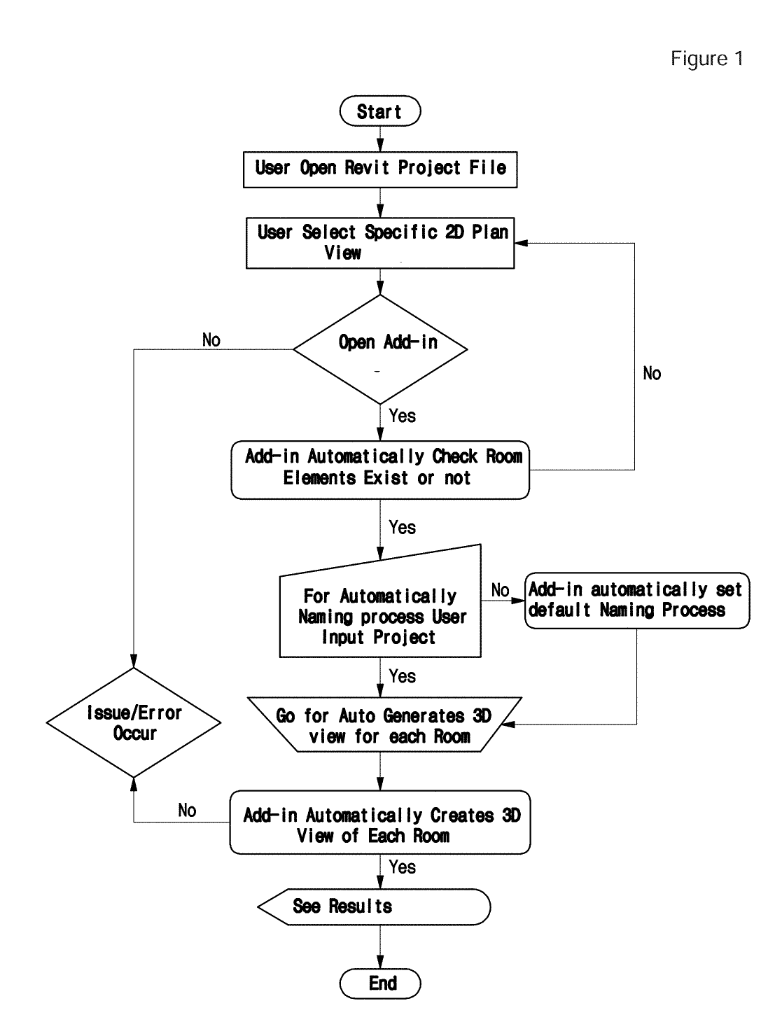

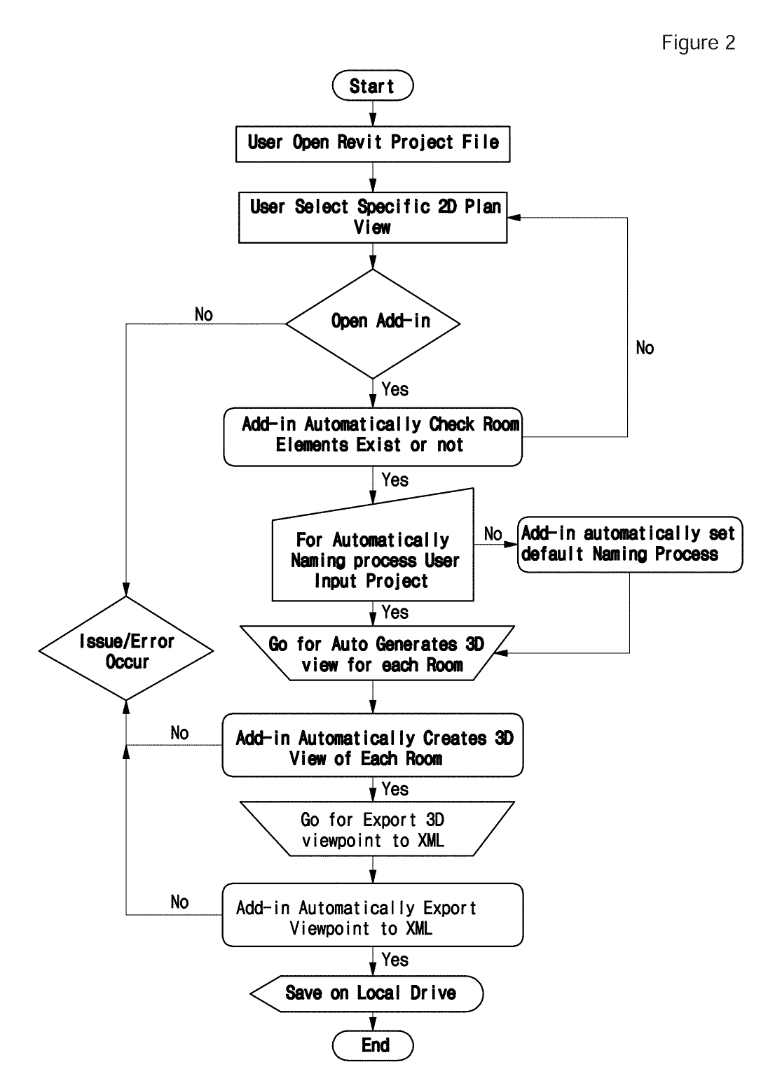

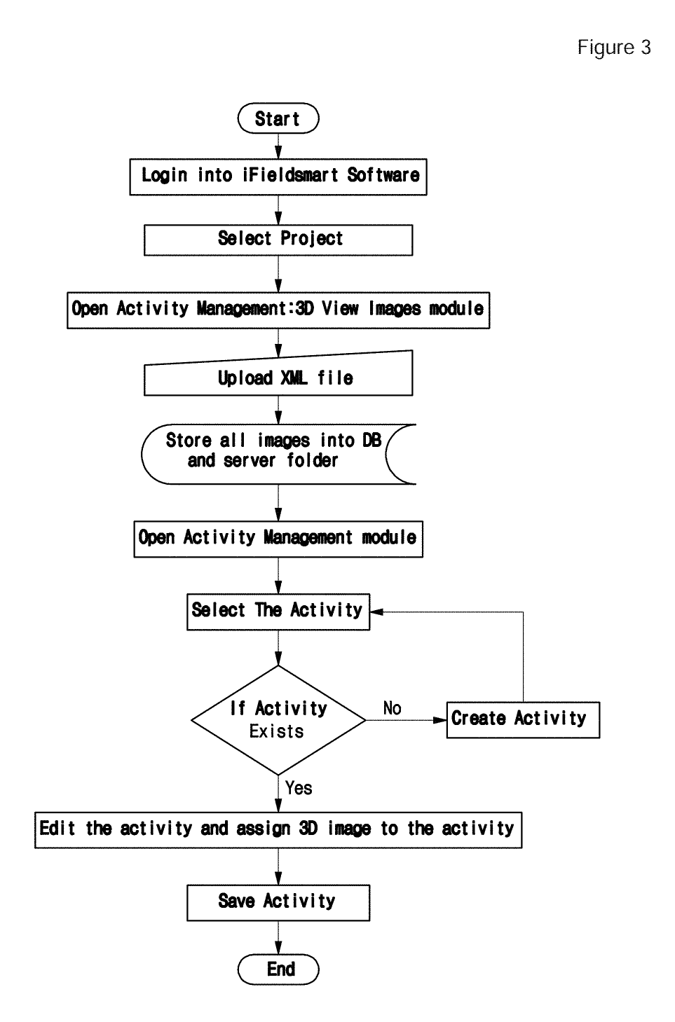

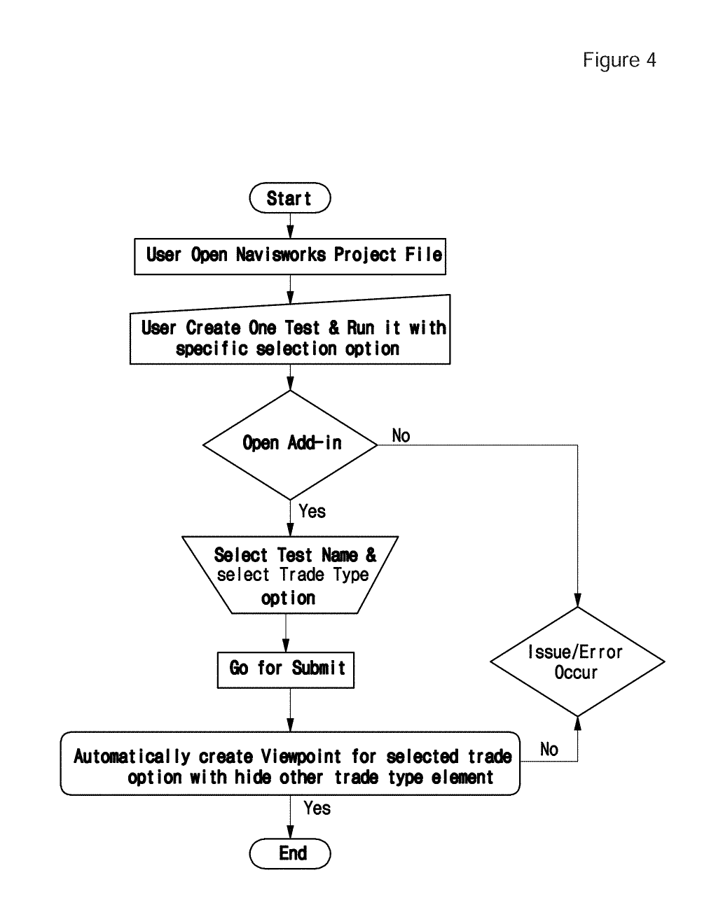

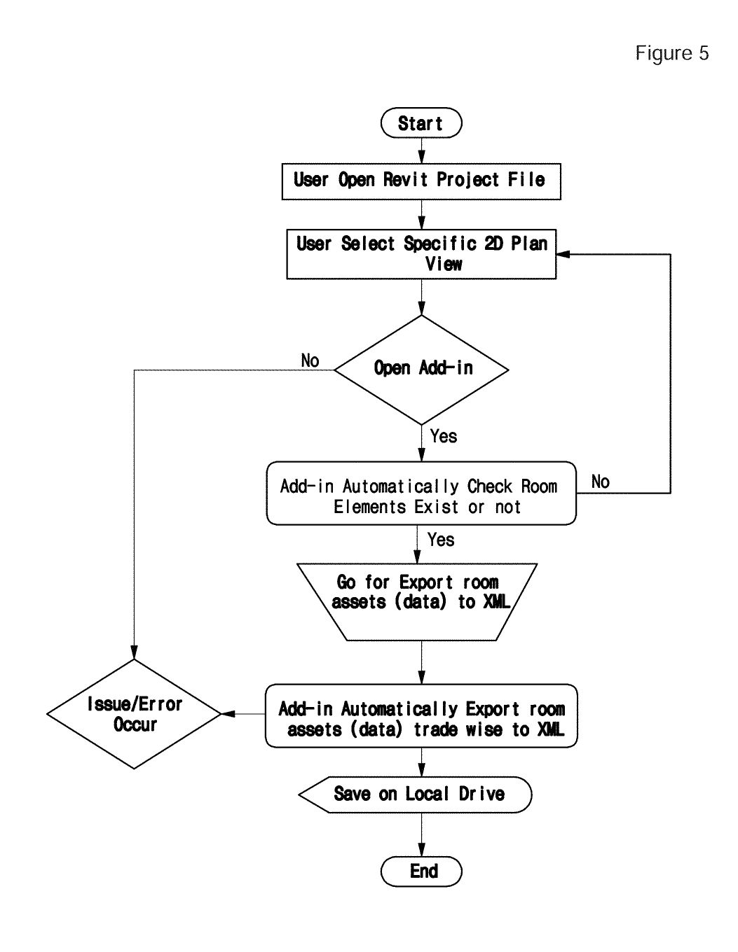

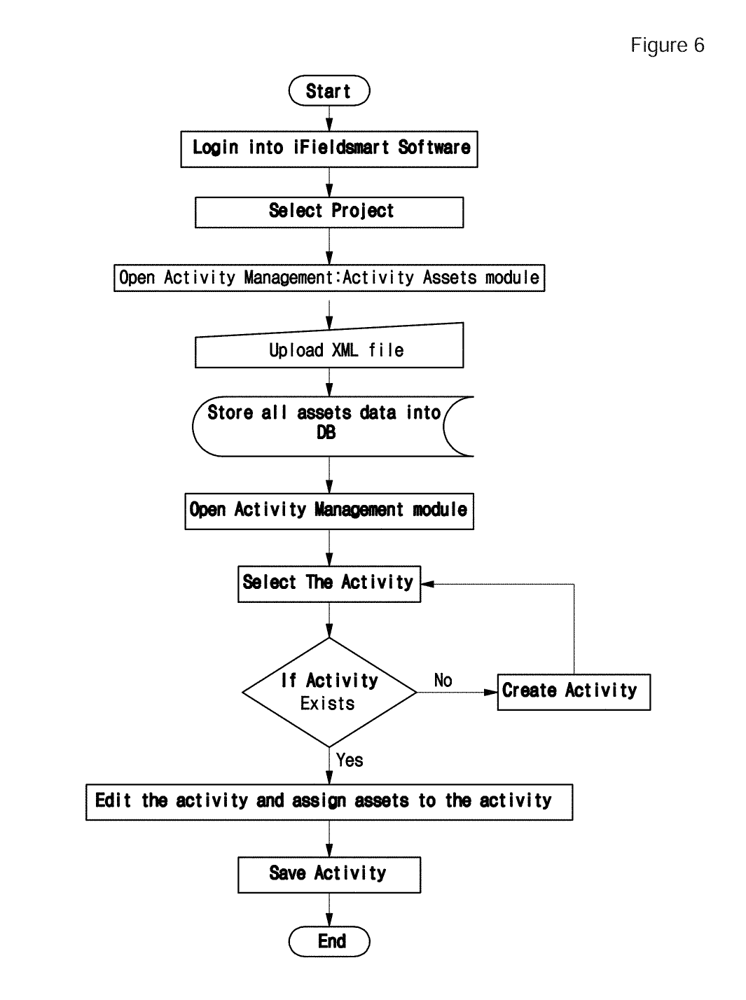

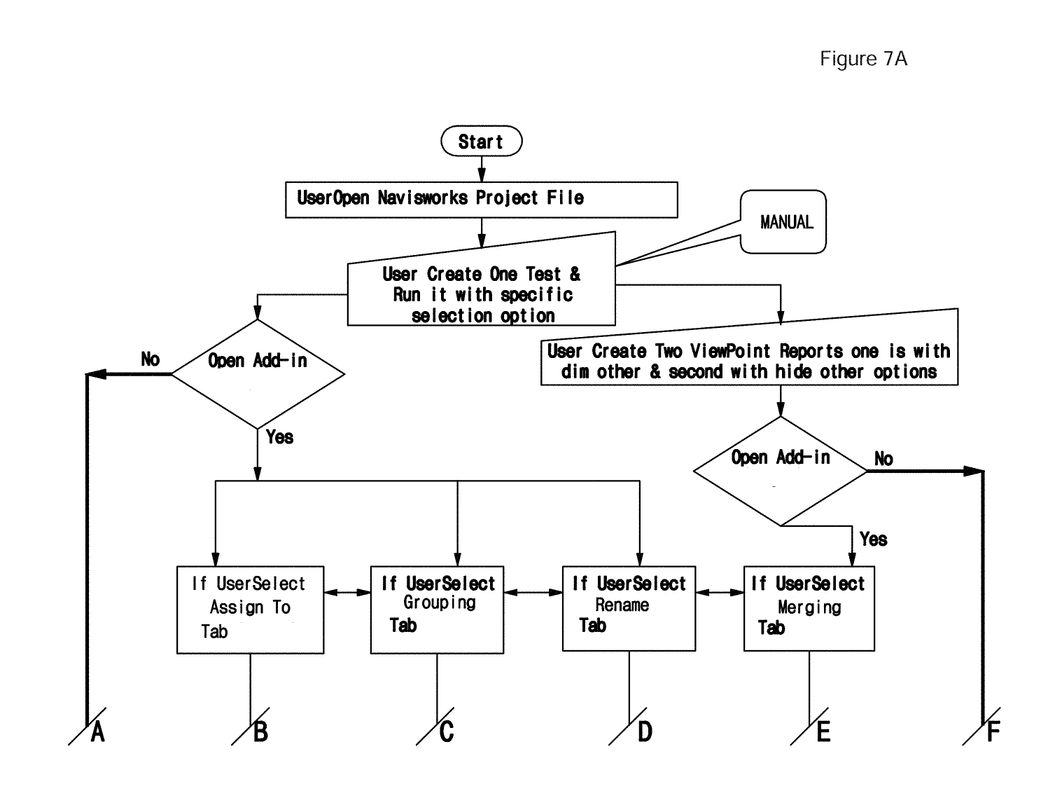

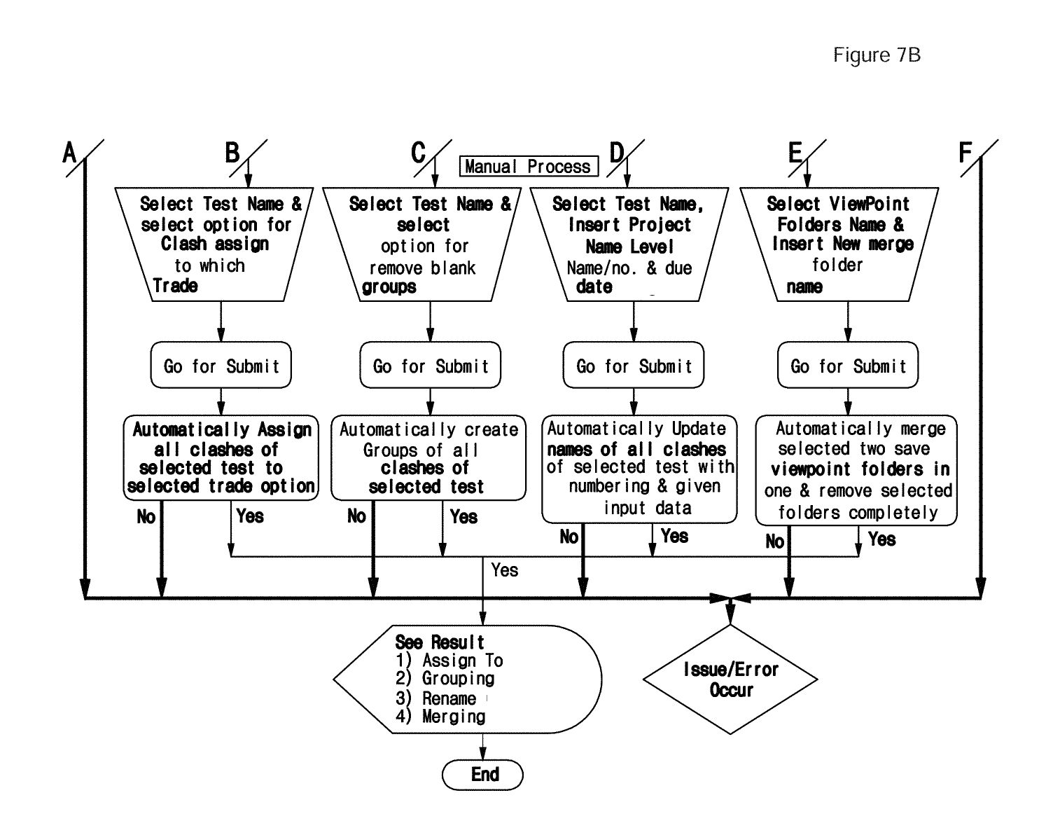

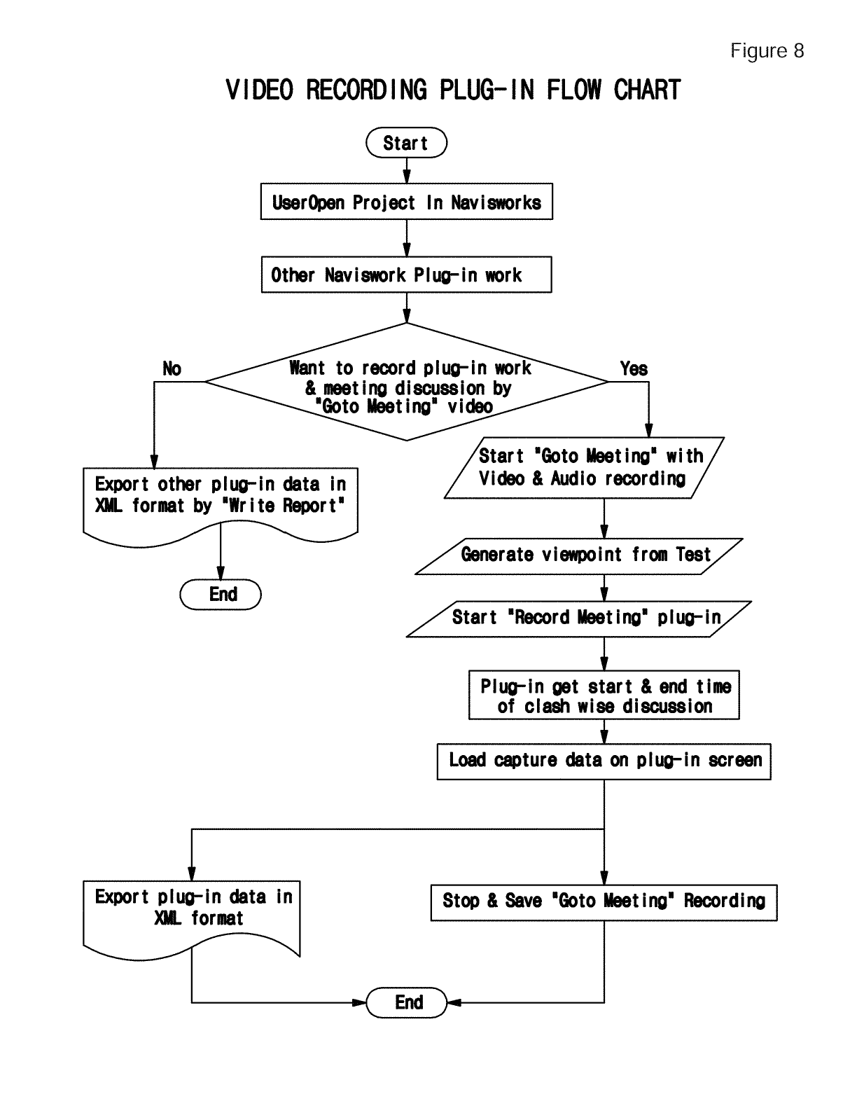

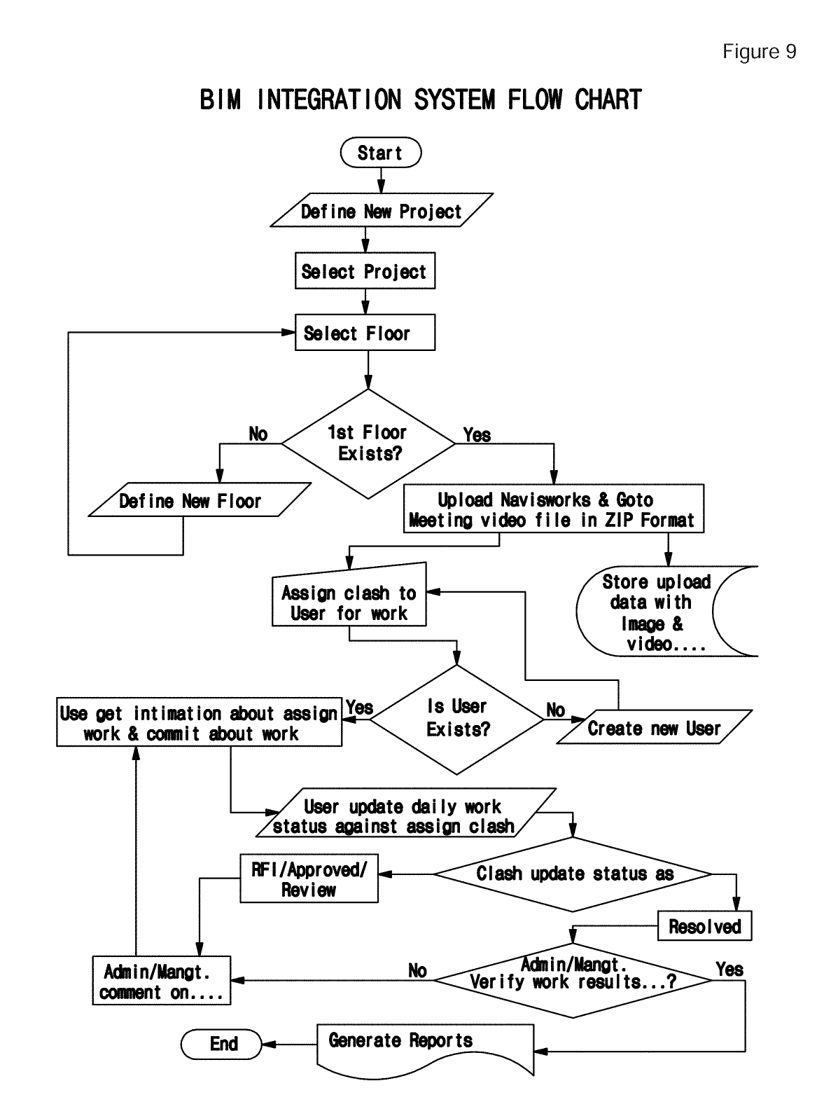

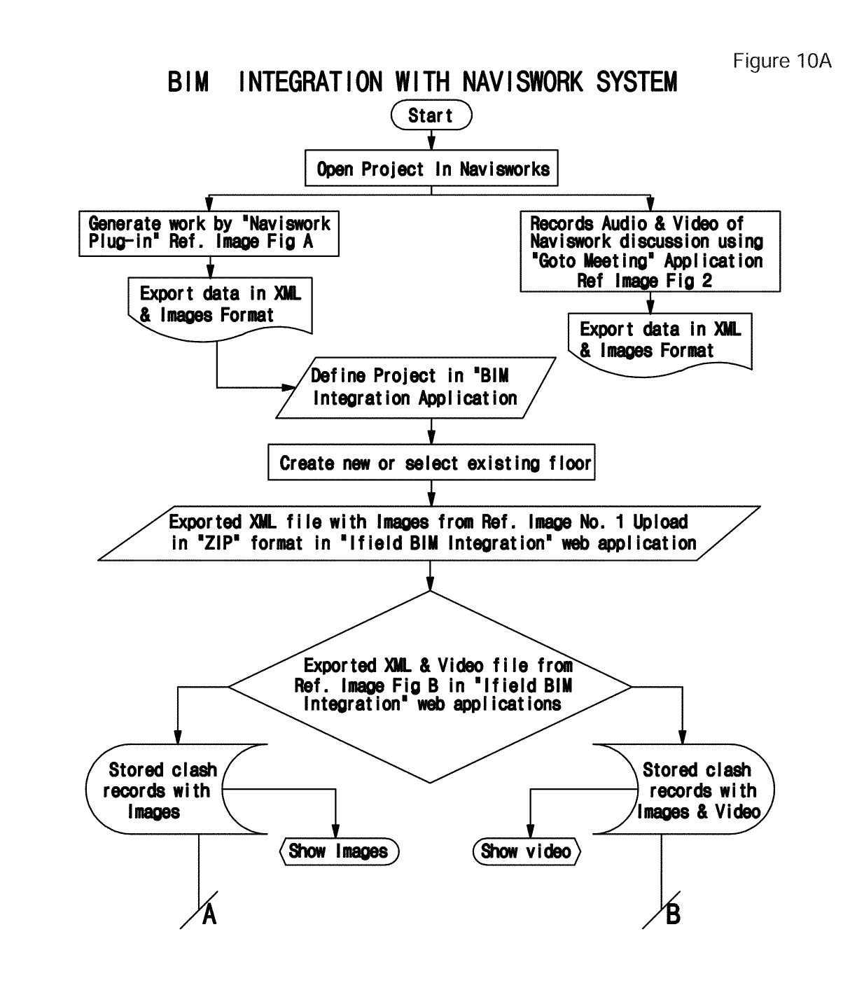

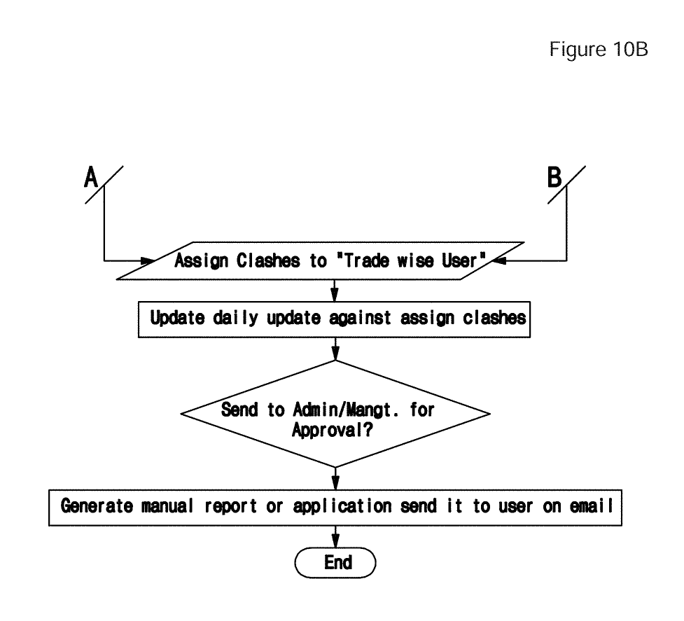

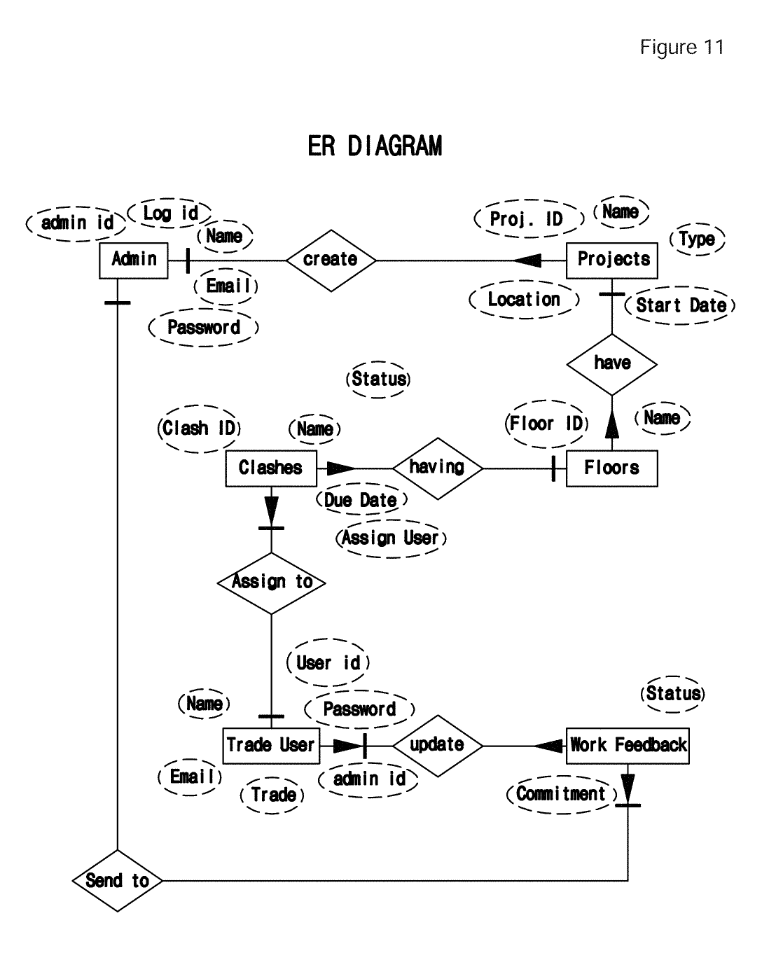

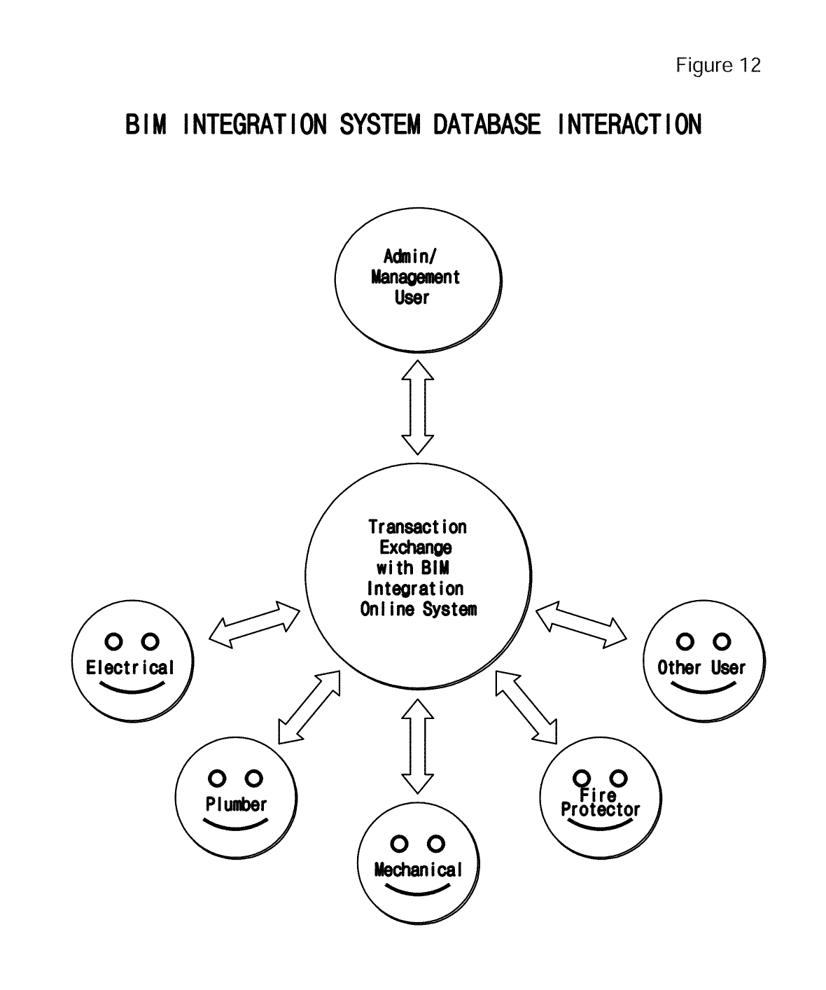

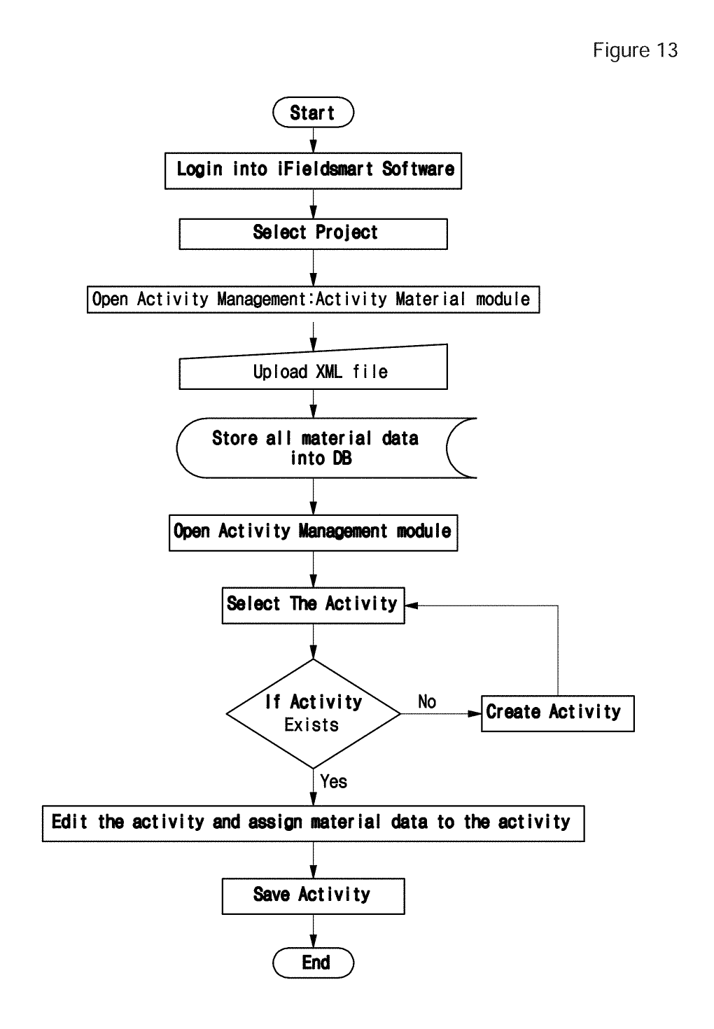

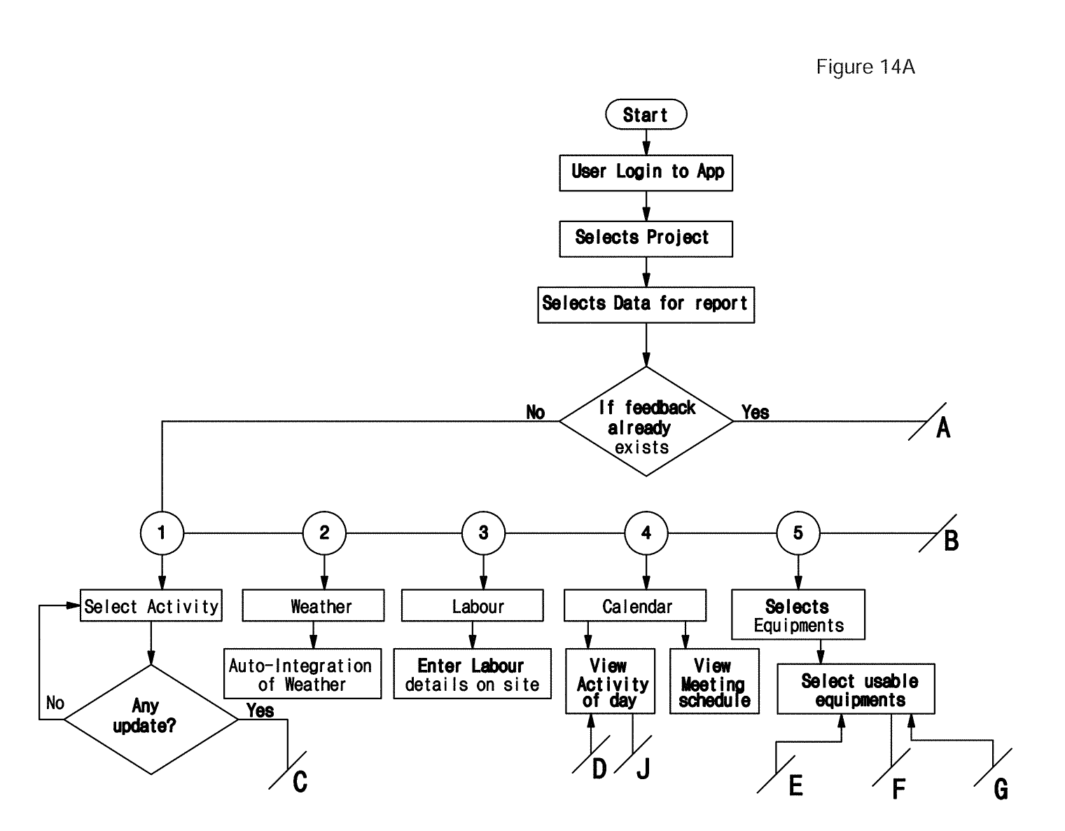

Referring now to FIGS. 1 through 14D, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention embodies a method for determining project data through virtual BIM data, wherein the project data may be integrated with the collection, integration and tracking of jobsite-related field data. One aspect of the present invention is to improve BIM management and field integration through tracking, collecting, and integrating jobsite-related data, documenting, integrating the communication and the interactions stakeholders are having between the data, thereby providing automated analytics for improved jobsite and overall construction project management. The method enables users and administrators to organize and coordinate BIM-model content (project data) using web and mobile application-based portals adapted to assign the clash resolution content to users and areas, adding timelines and additional comments, while managing and tracking such data.

The present invention may be adapted to provide back-end analytics and algorithms that compares current and historic trends on other projects for similarly situated content or project data, facilitating the generation of auto alerts and reports informing required parties of potential issues, whereby project teams may be proactively notified, allowing them to create proactive measures and avoid potential issues that can cause delays, cost overruns or create unsafe environments when resolving BIM clashes.

The present invention may enable integration and splitting of existing BIM models and project data into graphical viewpoints relating to asset, material and labor data for onsite crew, delivery management and commissioning. Furthermore, the present invention may be adapted to provide field data and integrated productivity charts by the various stakeholders/trades/parties, physical area, progress by notes and pictures, material management, and timelines of project for claims and analysis for construction teams.

The system embodied by the present invention may be adapted to facilitate automation in managing models through the following modes: automation in authoring models, managing and comparing model versions, integrating models, sorting its associated data and reporting the data to required parties; integration of recorded meetings (audio and video) with viewpoints and clash report issues; management, integration and reporting of open issues and clash reports; and digital sign-offs of coordinated models and drawings.

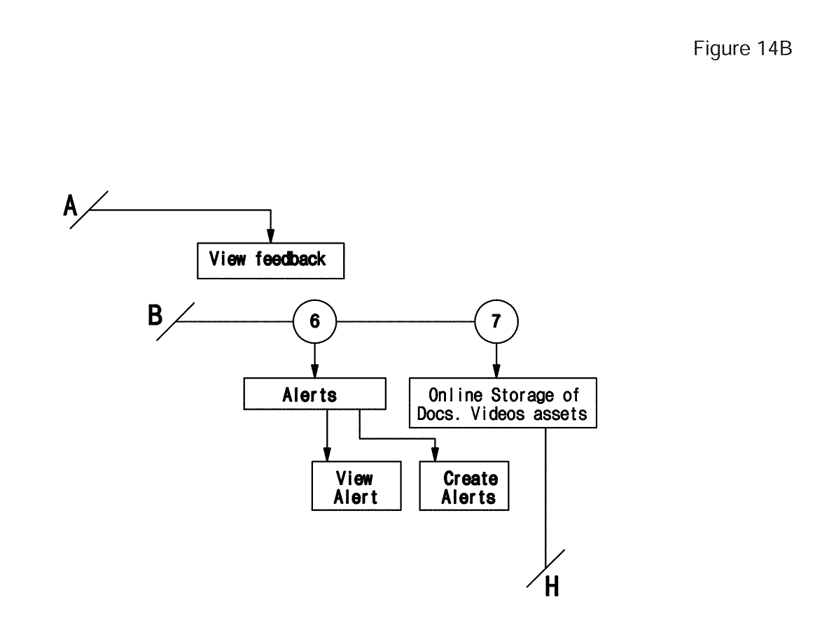

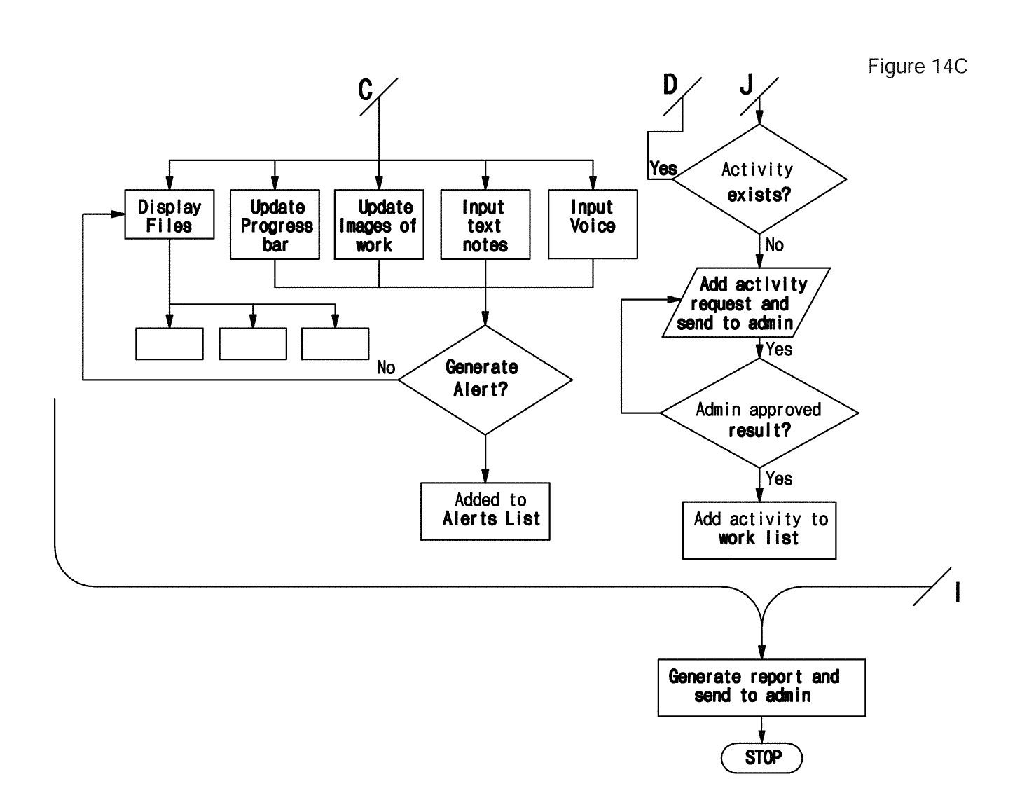

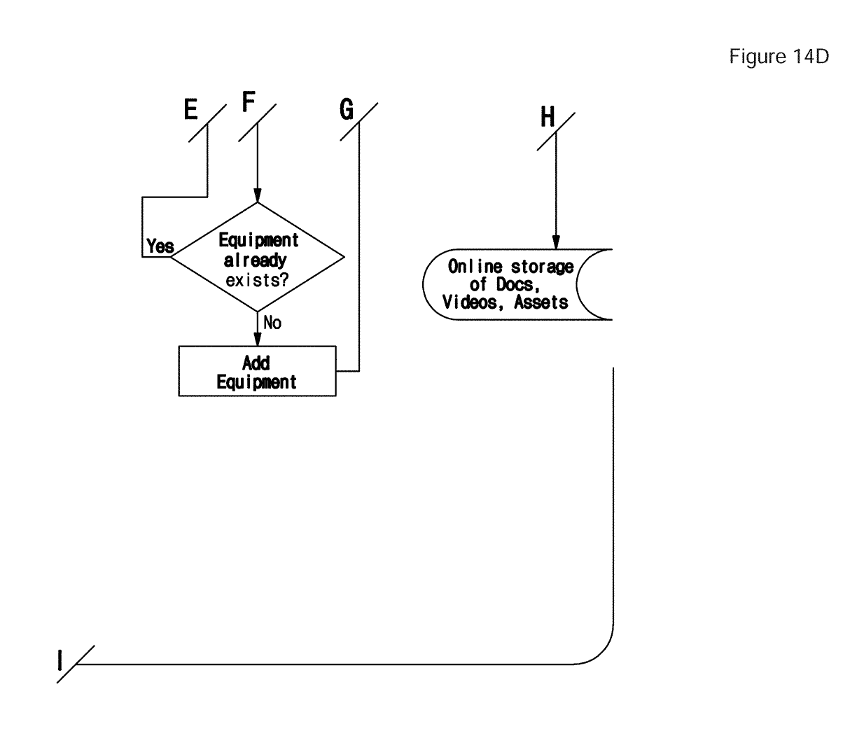

Referring to FIGS. 14A through 14D, the present invention may provide a iFReport modality (or just, “iFReport”) wherein iFBIM related data, such as 3D viewpoints, project data and assets may be integrated with jobsite-related field data from onsite crews associated with a relevant trade user/party/stakeholder. Assets may include deliverables of fixtures, furnishings and equipment, while project data may include assets, labor, material and an associated resolution of a respective task, or a portion thereof, as defined per each relevant trade user in iFBIM. The associated resolution may define the other components of the project data. Field data may integrate calendar data, weather data, and GPS data with project data through a scheduling modality, whereby each asset may be located in physical space and scheduled in a sequential relationship relative to other associated or grouped assets. The weather data can be incorporated in the scheduling and other time-related delivery predictions.

The iFReport may be configured to interlink the above-mentioned project data generated through iFBIM to field data and communication data. Field data may include information collected onsite at the relevant construction project(s). Field data may be gather at the jobsite via trade users by way of daily field reports in the form of progress video output, captured images, audio output of recordings, documentation related to the location and progress issues for each project data and associated resolution

In other words, iFReport is a construction management tool for interlinking the field-based progress data of a construction project with the virtual BIM-model project data, as well as integrating communication data to facilitate each associated resolution. The iFReport may be configured to interlink to iFBIM project data and thus BIM models, thereby providing field crews selective access to project and field data for each associated resolution. In contrast, the prior art requires trade users to large amounts of documents that might be outdated and/or irrelevant. The iFReport may be configured to interlink iFRIM project data to a scheduling modality. Project data may include assets, materials, labor, etc. embodied in a task defined in iFBIM, and the associated resolution thereof. Through the scheduling modality, progress relevant to the associated resolution may be tracked, managed, analyzed, and predicted. For example, progress in the field (in the form of field data) may be analyzed against the scheduling modality—enabling notification to assigned trade user—e.g., subcontractors in managing their work. The scheduling modality may include GPS data, weather data, and calendar data for facilitating scheduling tracking of deliveries and associated resolutions. The iFReport may be configured to interlink iFRIM project data and field data to a progression modality, where installation of assets (and utilization of materials and labor) may be tracked, through delivery of the assets to progress reports embodied in trade users' documentation until associated resolution up and through to an associated resolution. A lack of progress or status reports being indicative of an absence of the associated resolution. Specifically, iFReport may be configured to provide notification when deliveries are within a predetermined radius and/or when deliverables are running behind the scheduled time. Through such modalities, material, objects, and clash assets can be tracked and scheduled, and so inefficiencies, missed deadlines and overruns of labor hours and the like can be determined.

The iFReport may be configured to provide an activity management module. Through the activity management module, users can edit activities. Such activity edits may include the collection and integration of onsite field data. Field data may include audio and video files related to BIM project data and non-BIM project data. Such electronic files may be captured images of the assets, objects and location in relation to schedule activities. They may also be recorded information from the onsite crew of the relevant trade users and/or a meeting between various associated trade users, for example, the recording of a go-to-meeting presentation regarding the status. The files may also be documents regarding change orders and redesigns relevant to a specific object or asset.

As stated above, all the schedule modality and asset information may be integrated in the underlying BIM data or non-BIM data for a given project, whereby the stakeholders can facilitate focused issue and alert management, and thus manage and deliver a completed project in a more efficient manner through BIM.

A method of using the present invention may include the following. The system disclosed above and in the Figures may be provided. A user may create a construction project and fill in all identifying attributes of said project, such as project name, project type, contract number, proposed start date, and the like. Each project may be assigned a unique user ID and password, whereby the associated user may manage said project as an ‘administrator’ using said user ID and password. The present invention may be adapted to validate or otherwise impose restrictions on administrators.

The present invention may be adapted to prompt the administrator to divide a project (or building model) into a plurality of levels, sections or floors, through creating and selecting “floor names” for the given project. Such floors may be imported (or exported) from other projects or templates. Each floor may be populated with building components. The present invention may provide a window in the computer interface that generates a clash file capable of detecting and representatively identifying physical clashes between various components within the building model as well as between associated floors, such as between plumbing components and fireproofing components. Such clash file may be retrievably stored in a database along with a plurality of clash files. Each clash file may provide clash details imported through various formats, including but not limited to audio, visual and electronic files. Each clash file may be associated with a trade of a trade user, for example electrical, mechanical, plumbing, etc. The clash files may be sorted by each clash detail, such as status, associated trades, and the like.

Through the iFReport disclosed above, the field data can be integrated with BIM data, non-BIM data such as documents, meeting data and schedule activity modules to facilitate the efficient delivery of a BIM managed and field project management.

The present invention enables multiple users to assign themselves a trade (as a “trade user”) and to associated with a given project. For each object or asset, the present invention may provide electronic alerts to all users based in part by association of their trade/party/stakeholder with respective schedule activities. Such users may login to check the allocation of work, update their day to day status against related allocated clashes, issues or schedule activities files. The present invention may provide status notifications, such as RFI, Approved, Reviewed, Resolved and the like in order to sufficiently resolve issues, clashes and alerts.

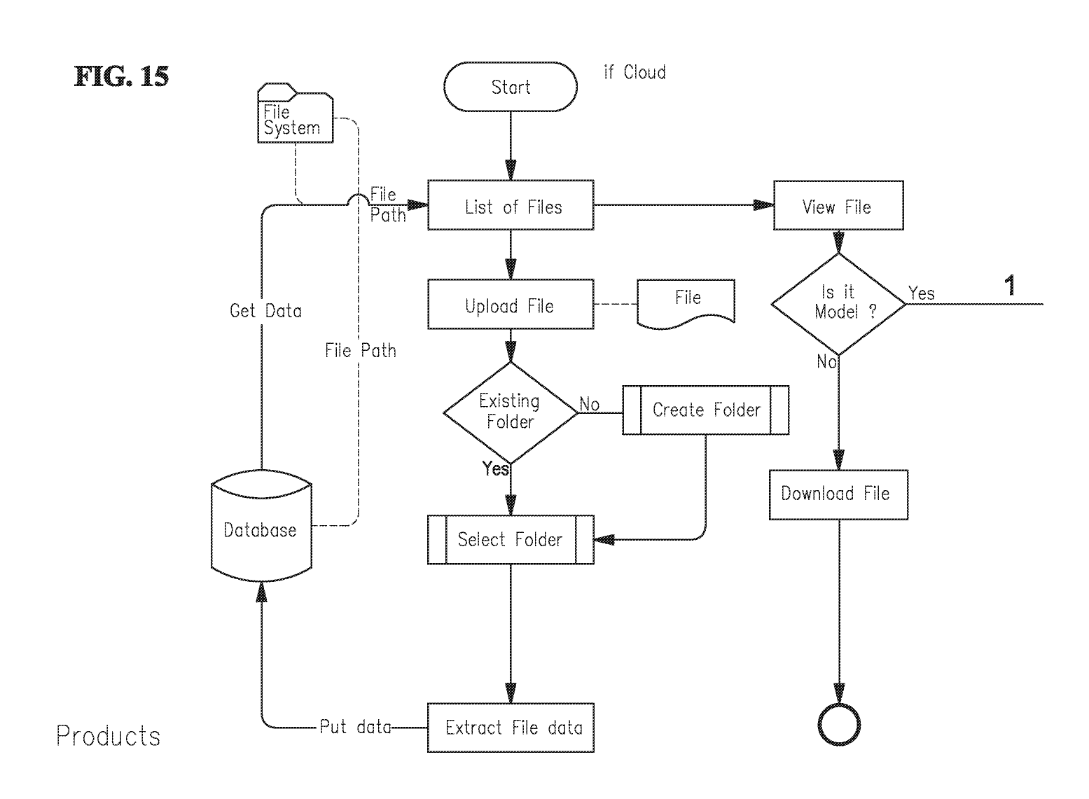

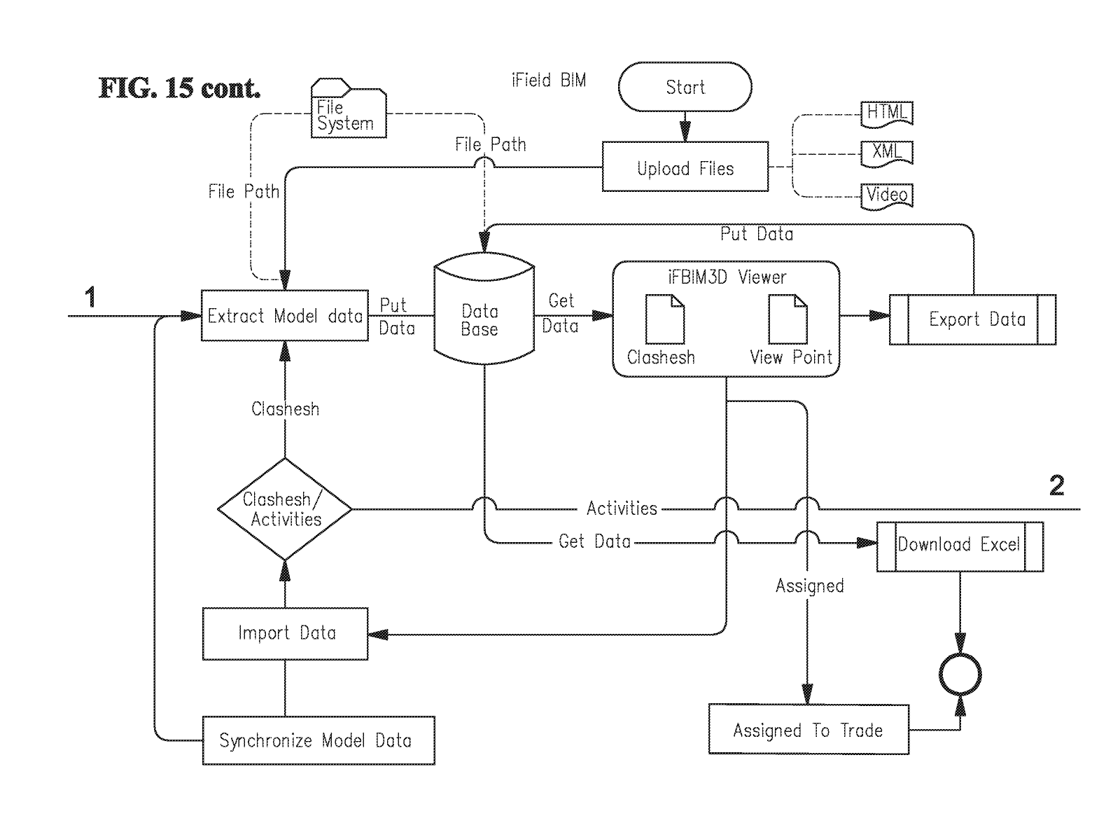

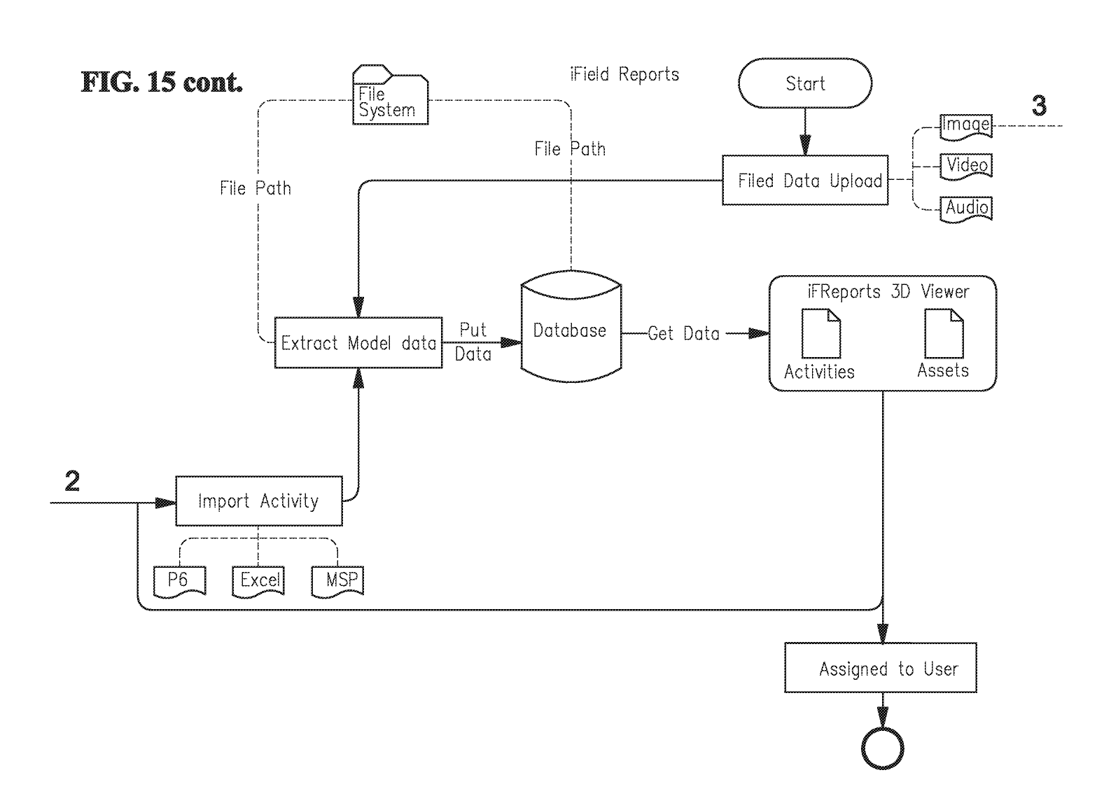

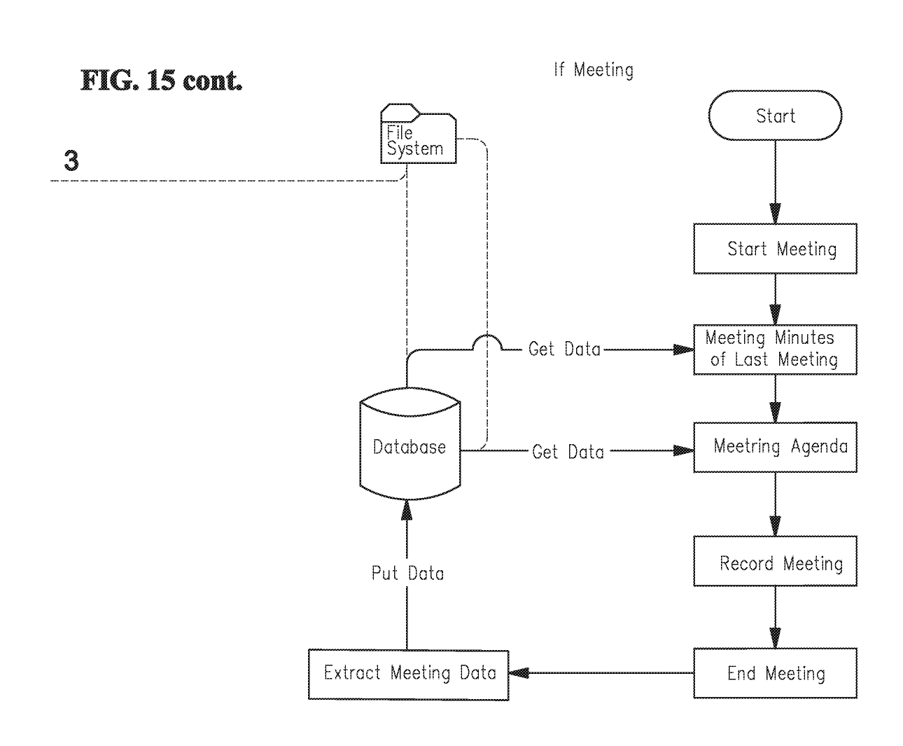

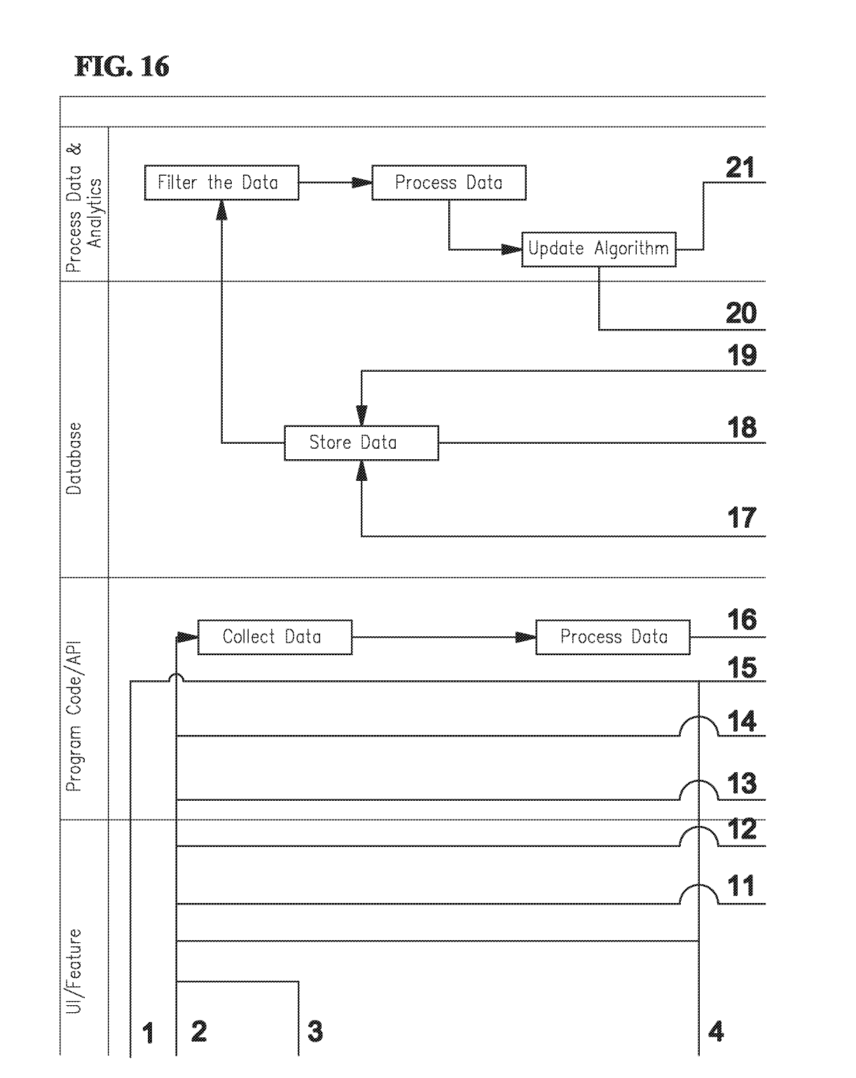

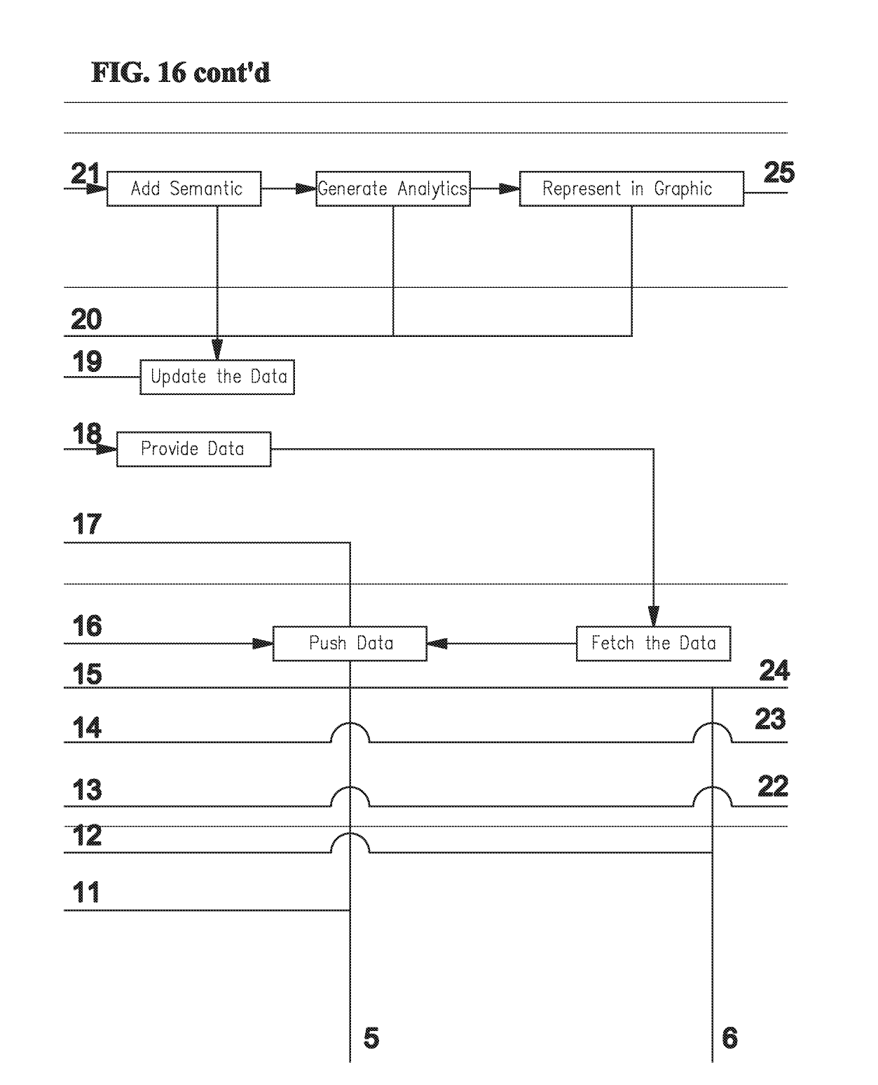

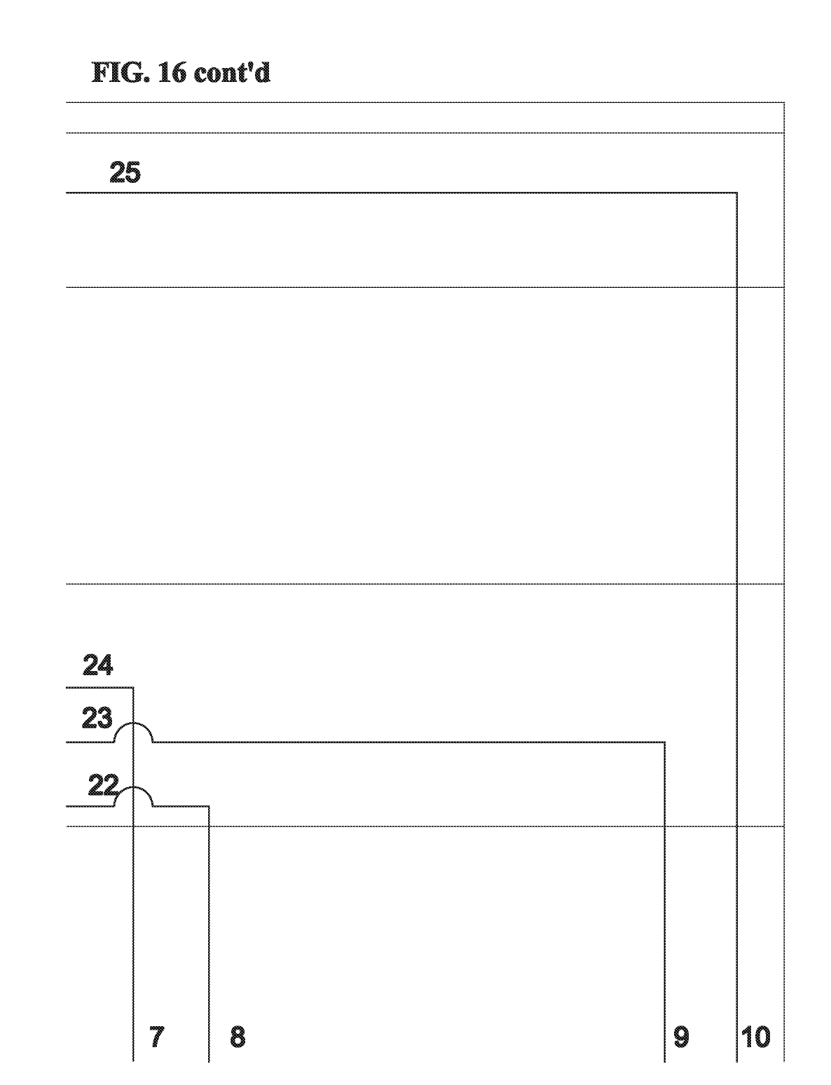

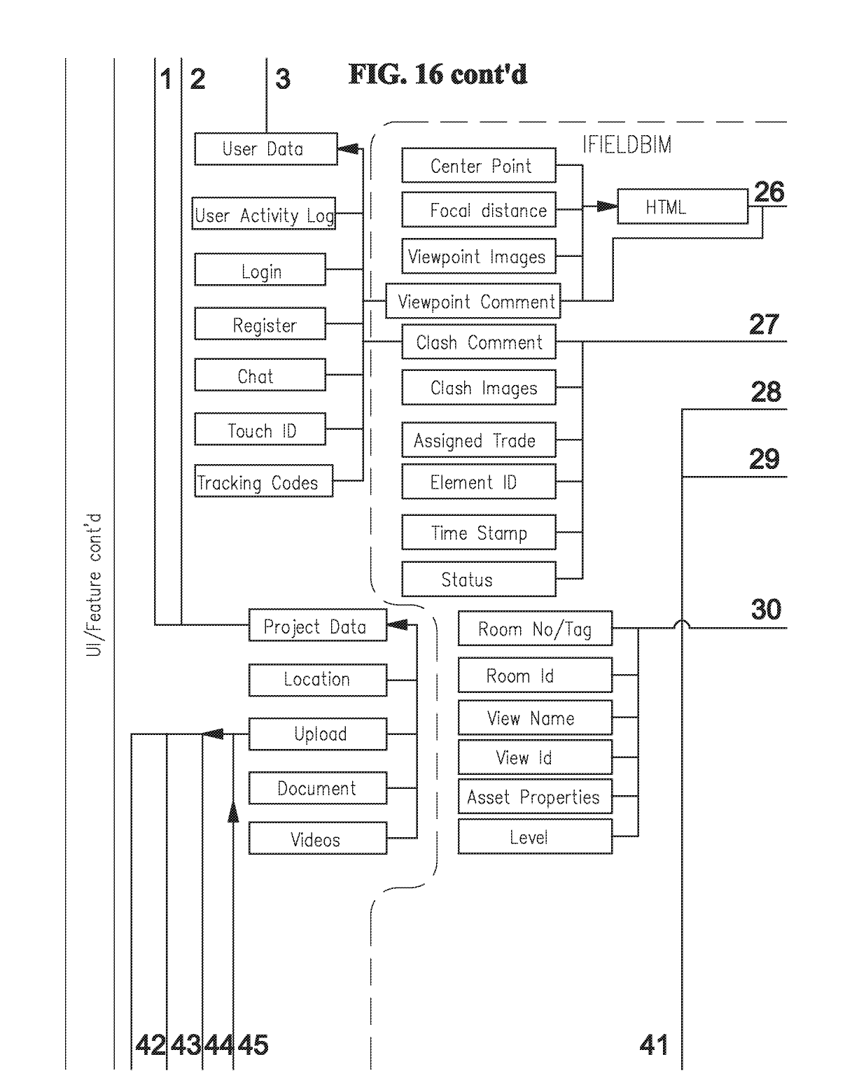

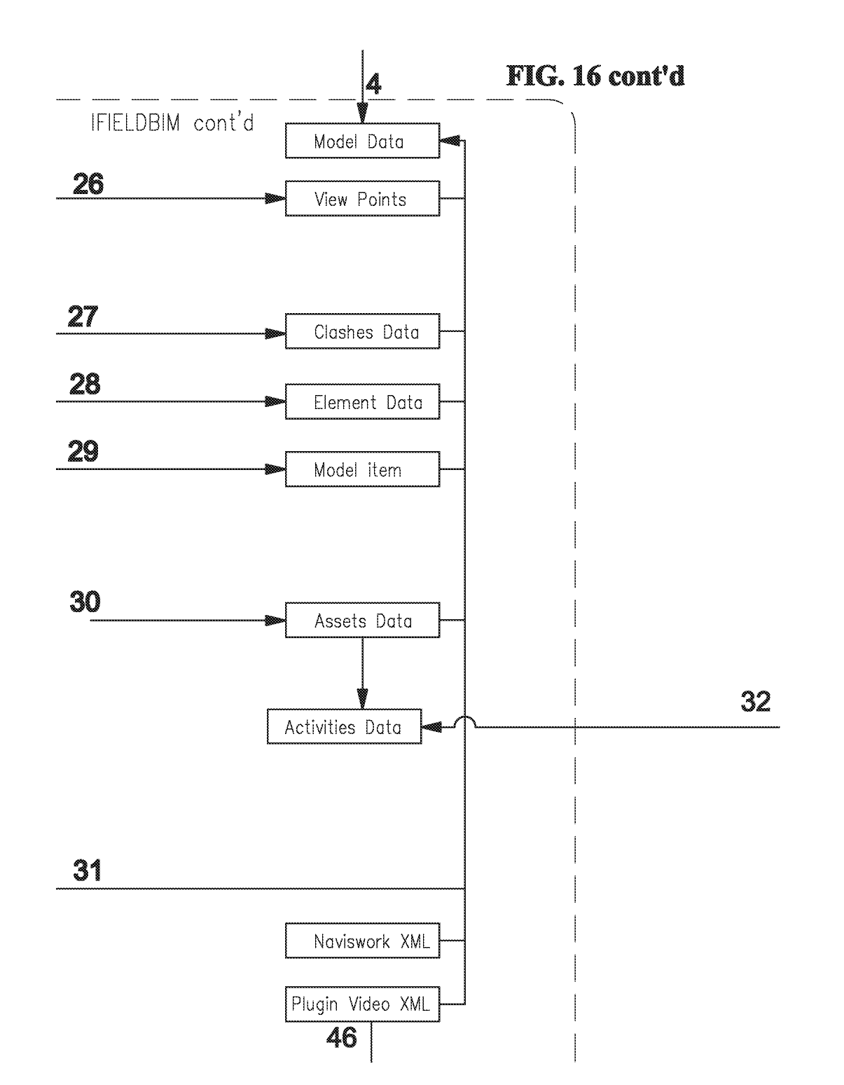

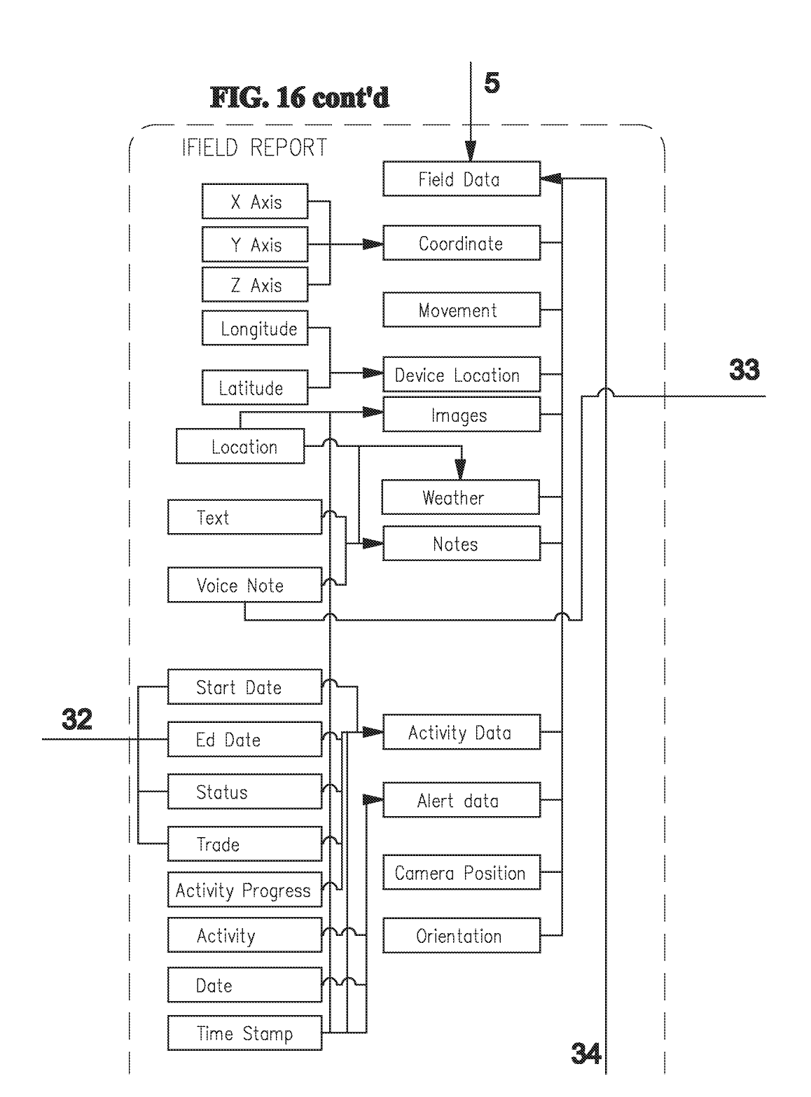

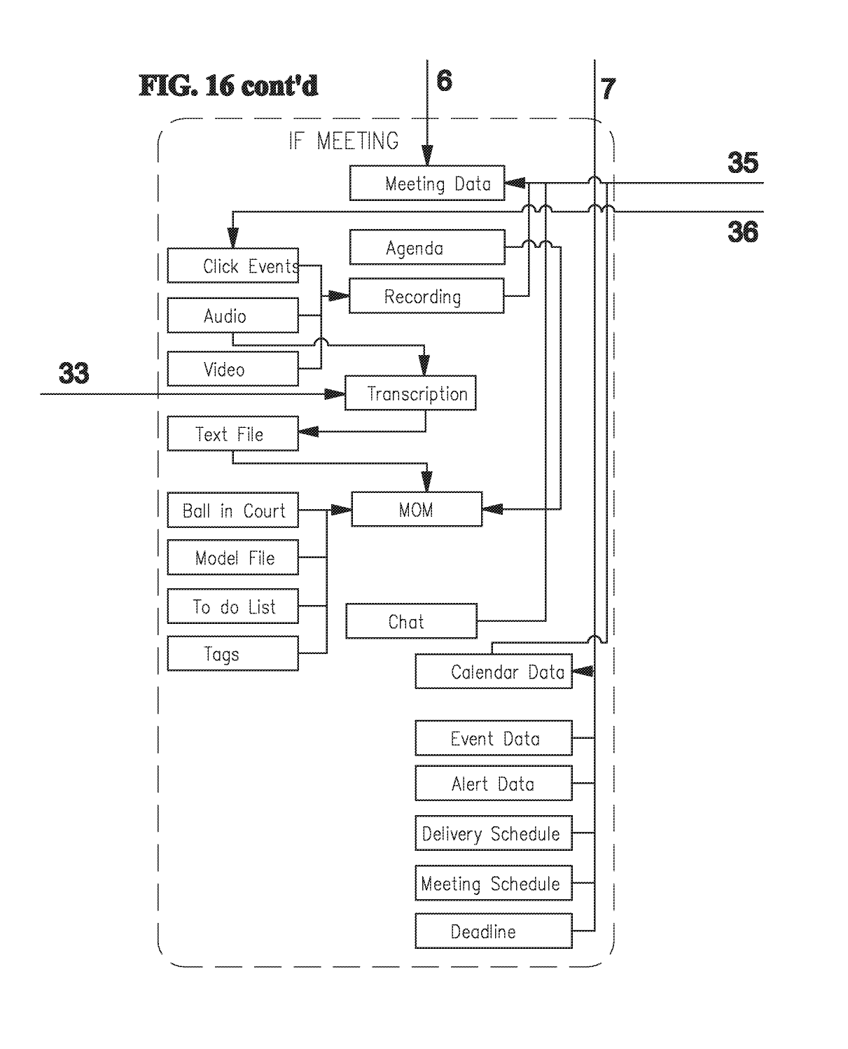

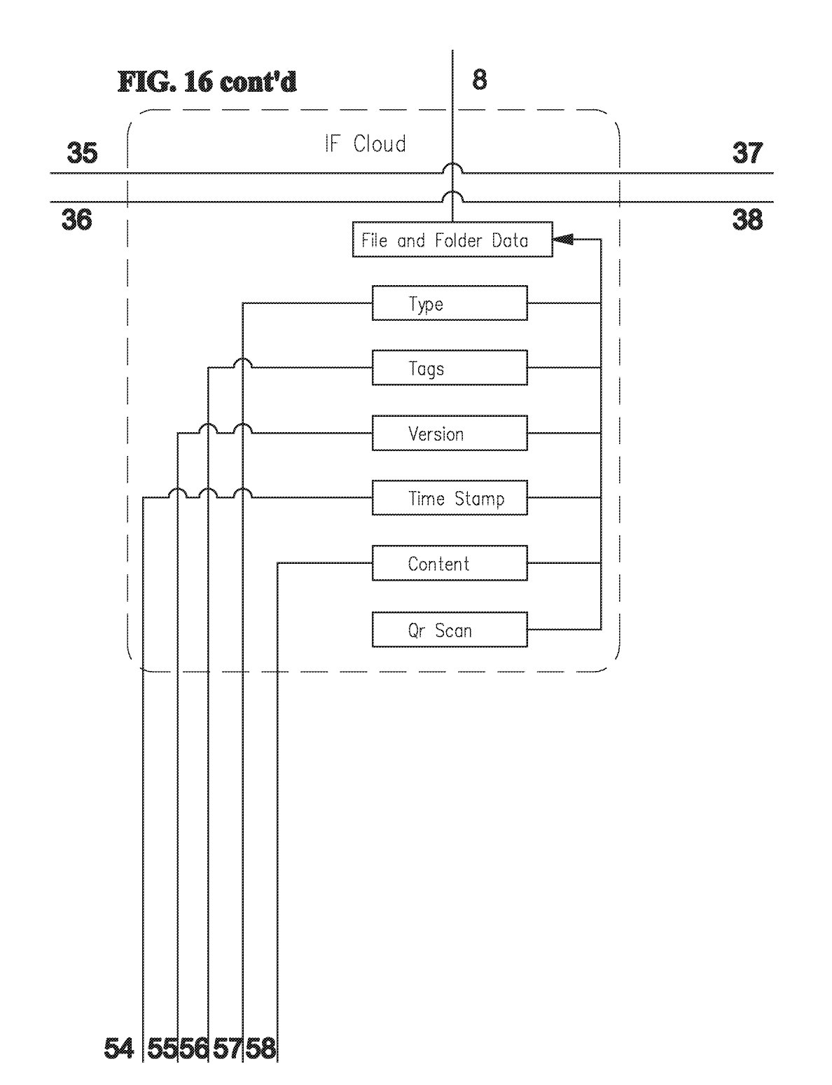

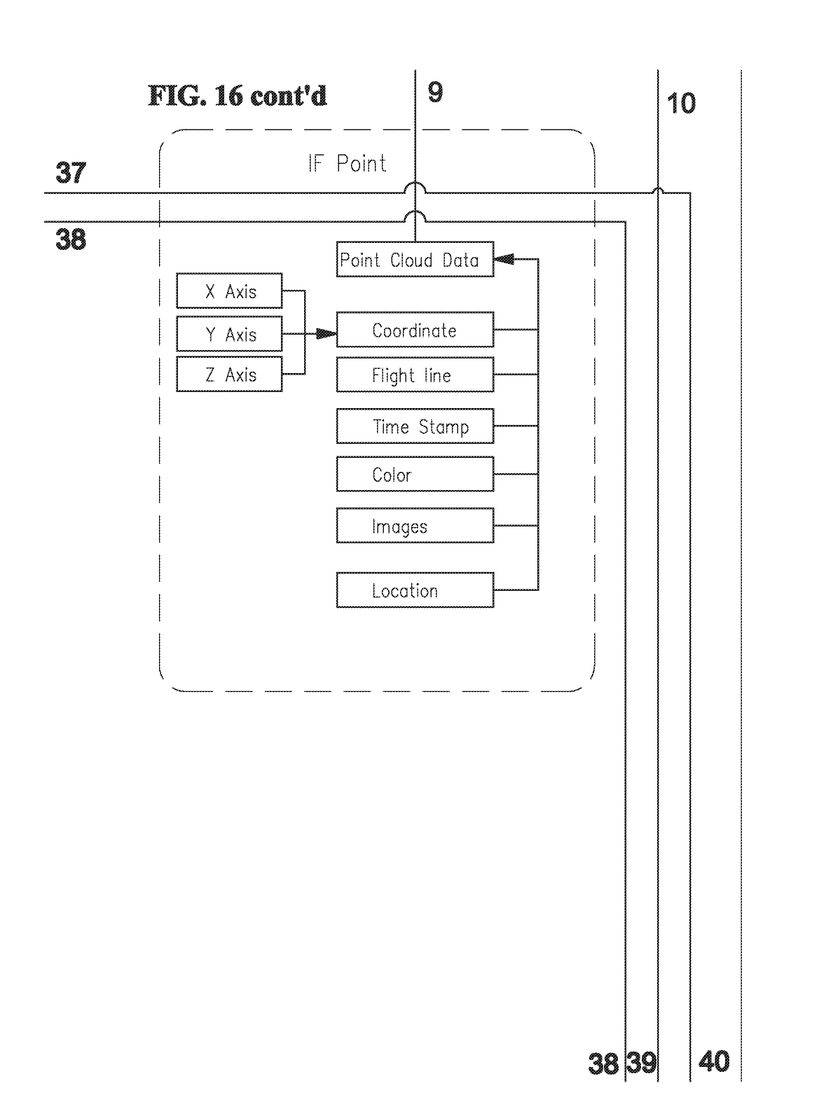

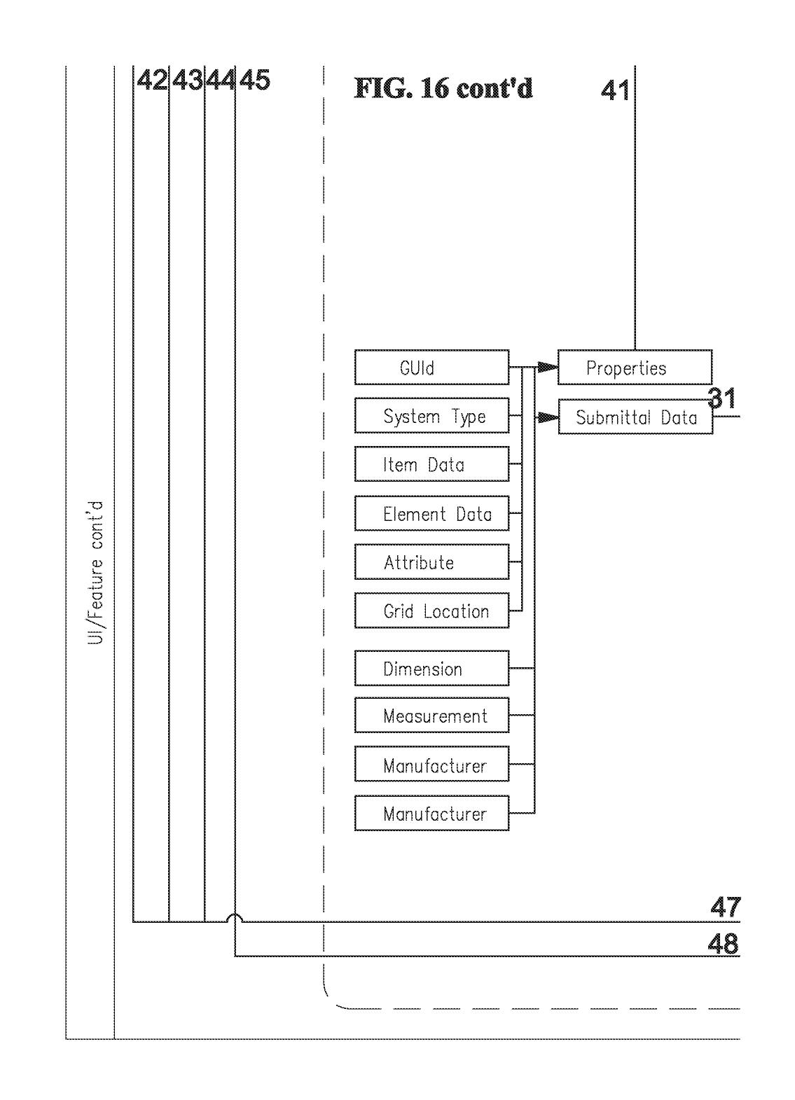

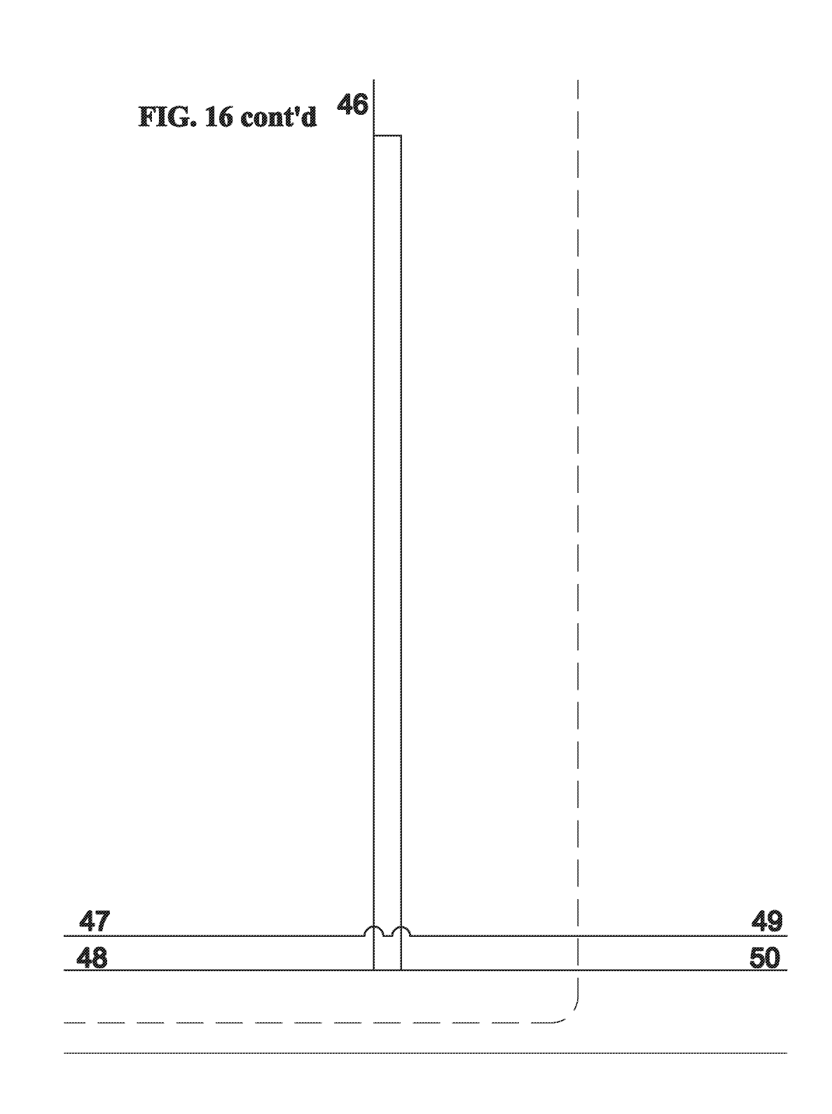

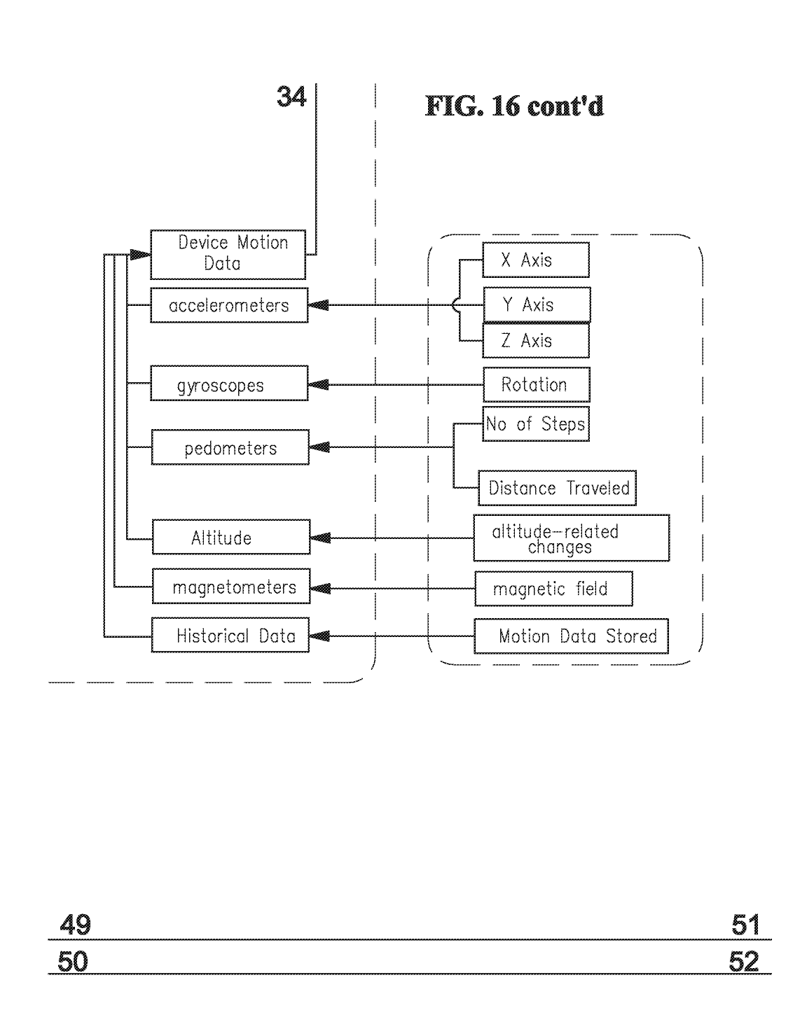

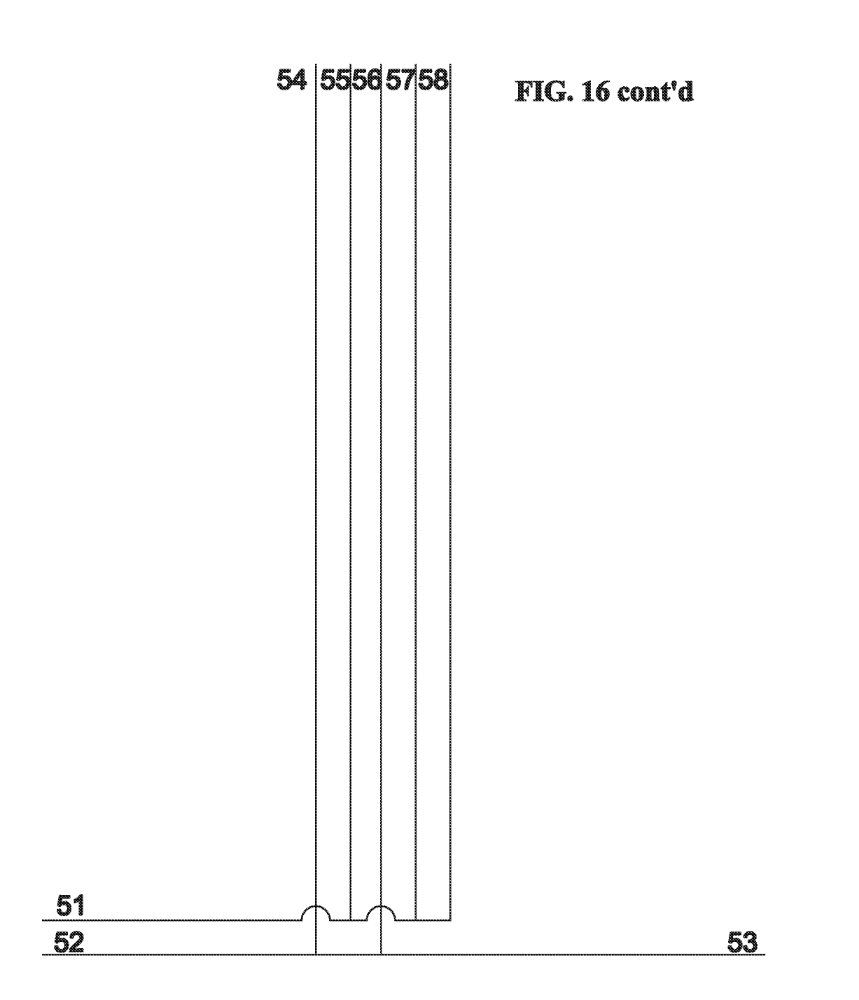

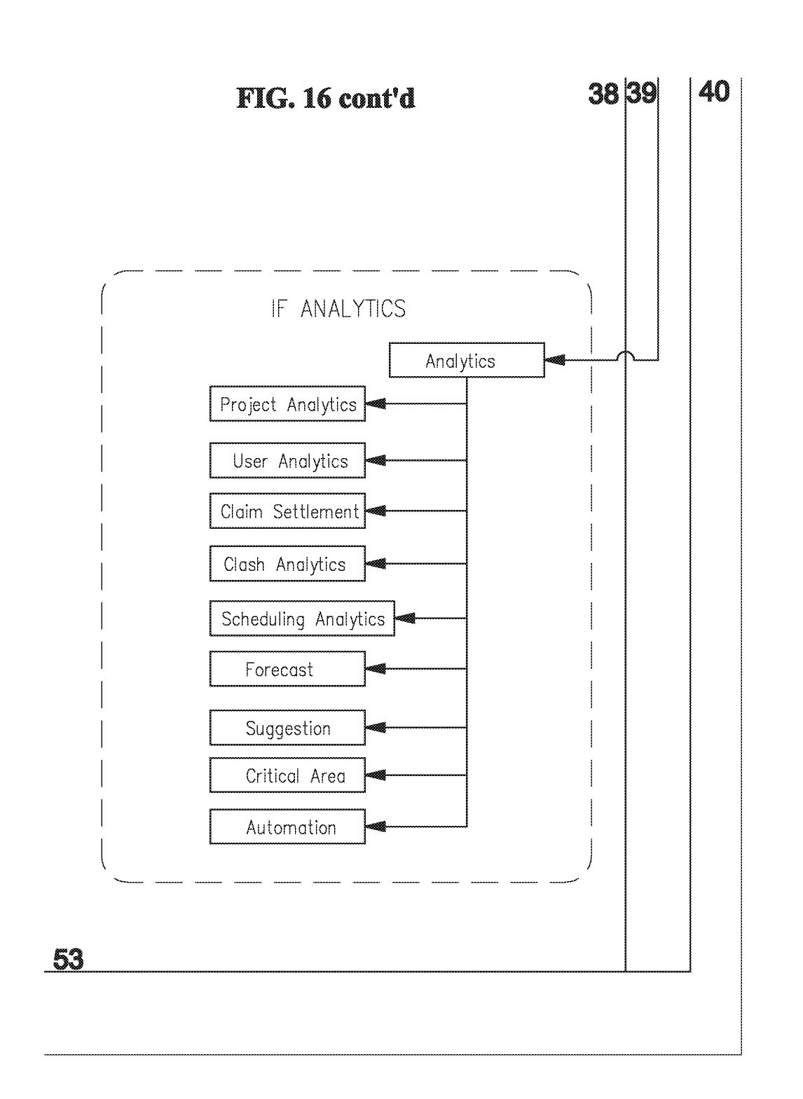

Referring now to FIGS. 15 and 16, the present invention embodies a plurality of components, including 1) iFcloud; 2) iFmeeting; 3) iFBM; 4) iFReports; and 5) iFApps.

‘iFcloud’ Component

The present invention relates to a method for file and associated data management on the cloud to enhance search results. Today's cloud includes document and files that are uploaded (like pdf, jpf, mp4), and that can only be searched by basic options—e.g., file name, time and user. The search will eventually filter a relevant file.

iFcloud provides a ‘live/Perpetual cloud’ having a workflow as follows;
1. Gathers data for various sources, like user location, various file format (pdfs, doc, dwg, nwc, mp4, jpg etc), time/date, activity, etc.
2. After gathering the data it will then scan the data in text, content and other searchable data formats.
3. Data base at the back with then interlink all relevant data by matching text, time, people, location, etc.

iFcloud provides the following features:
i) User can search the time—results will showcase all files not uploaded by user but will display other files that were shared by other users during that time period (example—2 hours before and after).
ii) User can search people—you can search all files associated with the different trades.
iii) User can search location—you can search a document if you remember where you were—results will showcase all files not uploaded by user during that time but will display other files that were shared by other users in that location.
iv) User can search key word in the file—for example you can search ‘paint color selection’ and the results would show all file with the key words. You can then filter out by time, location, etc. to find the file.
v) If a video files is uploaded—iFcloud will transcript the video, so that the you can search the file by the what was discussed and result will show the video clip.
vi) Image uploaded will track location and possible faces to provide results that are people based, location or possible content based.
vii) Combined search—
   ‘iFmeeting’ Component

The present invention relates to method of conducting and documenting meeting to enhance project management. iFmeeting enables users to manage meetings in a more integrated format for engaging downstream users that were not part of the meeting but need access to meeting information. Rely on first-hand information.

Today's meeting formats include the following disadvantages:
1. Meeting is conducted by team managers in physically format. Points are noted down by respective leader as they perceive them. This information is then transferred to sub-leaders and so on downstream each taking what they understand for the point gathered from main leader. Result is delay from unclear information or deliverable that don't match the intent. Multiple formats of same file are typically circulated.
2. Virtual meeting—Conferencing call video or audio are becoming very common. But just makes the problem from point ‘1’ more drastic. Follow up is almost difficulty or in silo. Best output you have is a recorded meeting. Try find who said what after 100 meetings listening to videos.

iFmeeting provides the following features:
i) Creating an agenda and inviting people to the meeting. Agendas are at the center of this technology. Data is structured around the agenda to get an end-to-end life cycle. The data around the agenda and pertaining life cycle can be systematically generated on demand by searching systematically converted metadata. Meeting outputs—video, clips, recording, notes, etc. are associated with agenda topic making it efficient for further analysis.
ii) Organizer invites people to the meeting—capture location, title.
iii) Video/audio meeting is conducted by organizer goes through the agenda or a file that is reviewed, meetings can be initiated with just a click using a file. The file becomes the discussion topic.
iv) Organizer goes through the agenda or a file that is reviewed.
v) Meriting takes place—Attendee joins meeting and receive all related information for that meeting. Related information is systematically queried in the backend allowing pertaining data to be sent to all invitees.
vi) At the back end the audio is transcript into text.
vii) At the back end the product keeps track of which agenda item was discussed and who spoke.
viii) Video clips are created with who spoke, agenda discussed added by transcripts.
ix) These video clips are attached to files that were used, agenda discussed and person speaking.
x) Any user downstream has direct access to video clips in short, specific format to review.
xi) If you open files during discussion, they will show relevant video clips and people transcripts.
xii) Meeting search by agenda, key word discussed, people and files used is not possible.

This integrated meeting functionality facilitations the next level of project management. Once the meeting is adjourned, users may receive a well formatted action items with details as discussed in the meeting. In addition, a segment of the meeting discussing the agenda will be sent to the user along with all related attachments. A full transcription will also be available on request. This ensures that all irrelevant information is not shared with the user for an agenda, making the data more management and meaningful.

The data is analyzed, and all pieces of information are put together to make the use of data more ‘meaningful’. With Meetings, the user can not only record the file but the audio data is transcribed into text. The system associates the text with the agenda, user, time, location and after systematic analysis the meeting is broken down to more manageable and meaningful pieces. Each piece of information is related an agenda. Within this the data is organized by timeline of who said what and when.

‘iFBIM’ Component

The present invention relates to method of managing BIM data, collaborative BIM meetings and improving BIM project management. Although, BIM provides advantages to constructions, it continues to struggle with following items;
1. Data collaboration downstream to data authors
2. Communication workflow between team players
3. Virtual issue management.

The current solution, or lack of one, leaves the users and managers with abundant data to sort through, examine and then determine which data to assign downstream to modify the data to solve the issue. This is not only a cumbersome approach but it sometime creates duplications of data changes undermining the productivity. Also, more importantly, the lack of better tracking and reporting of issue in timely fashion exposes the project to delays or last-minute crises.

iFBIM is a platform, tool, system and a method that enables BIM managers to efficiently manage the data, users and virtual issues in a structured format allowing improved workflow downstream to data authors and reporting analytics for mangers to take proactive decisions potentially increasing productivity and reducing risk for projects.

Overview of the workflow of iFBIM:
1. BIM coordinator performs clash detection.
2. User will then use iFBIM to organize, name and assign the clashes to users in organized format.
3. As a standard process today, BIM meetings are conducted by the BIM coordinator to discuss issue with other trades and associated data operators. iFBIM tracks this meeting as the organizer clicks through the issues and provides solutions.
4. iFBIM then enables integration of video and click event to split video into small video clip pertaining to specific issue.
5. IFBIM then syncs all issue with assignment to all parties/trades allowing them to access only relevant information and video clips provide first-hand information on solution to user that where not part of the meeting.
6. Teams continue to discuss solution in IfBIM platform pertaining to an issue keep all the relevant data together for quick access and fast decisions. Also, it helps report the decisions in more interactive format.
7. As the issues are closed or discussed the assignments can be changed to a new user allowing them to have immediate access to associated data history.
8. The system allows reporting that enable to focus on key issues that productivity that could delay or create potential risk for the project, enabling to take proactive actions.
   iFReport Component

BIM can help visualize the problems but building as built in real time with real people. Quick BIM data access, relevant BIM data access in timely fashion and integration of BIM data with field data is extremely crucial for success of the project. Time and time again, a good BIM models or data due to lack of access creates field issues defeating the purpose of early planning. Frequently, field variations from virtual models create for unforeseen issues delaying the project and impacting productivity.

IFreport is a system, tool and method that mainly focus on bringing this gap between virtual data and field data by integrating the two, and provide analytics that helps improve progress by providing quick and relevant data to field and more importantly creating analytic by comparing the two data points identifying the issues proactively and helping managers solve them before they become an issue.

### Overview of Application and System

1. BIM models are migrated from iFBIM to iFreport and resulting project data is segregated at backend into four data sets: asset data (e.g., the type of asset involved, such as a door; geometric data (e.g., the size of a door); location data (e.g., wherein in the BIM model is the door to be installed); and documentation data (which may be field data and or communication data related to the project data).
2. These data sets are then interlinked with scheduling modality and progress modality. Interlinking is done using scanned location tags (floor, room name, etc.), asset tags, industry specific tags and project specific.
3. Project schedule or schedule modality connects to relevant asset data and geometry data, which are interlinked to meta data (e.g., color of the door or a contact number for a trade user associated with the door) and trades users, indirectly forming first mesh of interlinked data, connecting project data (e.g., assets) to a trackable schedule.
4. Field data like delivery time and progress documentation, weather data, trade user information, and the like coming from the jobsite of the construction project is connected to the project data, forming a second layer of mesh.
5. The third layer of mesh is communication data received via iFMeeting and laid over relevant to project data and field data and documentation of, for example, geometry and status of asset in construction work flow.
6. The result of this three-layer system provides in-depth analytics and forecast with relevant interlinked data that will help field and office manager focused decision to avoid delay and improve productivity.

More important this data get transferred to O&M personal that will be utilized for building maintenance allowing them to get data of design and field construction data helping improved management of building in life time of the project.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A method for improving a building information modeling system for a construction project, comprising:
coupling a field reporting functionality to the building modeling system;
the field reporting functionality configured to:
obtain virtual project data relating to the building modeling system, wherein project data is associated with resolution of a task of the building modeling system;
provide a schedule modality configured to a first timeline for both a delivery of the project data and a second timeline for an associated resolution to the project data; and
provide a progress modality configured to link field data from a jobsite of the construction project to the project data.

2. The method of claim 1, wherein project data includes at least one asset required for the associated resolution.

3. The method of claim 2, wherein each asset comprises geometric data and location data, wherein geometric and location data is defined by the information modeling system.

4. The method of claim 1, wherein field data comprises video, audio and textual output linked to the first or second timeline.

5. The method of claim 1, further providing a meeting functionality configured to generate communication data linked to the first or second timeline.

6. The method of claim 5, wherein communication data comprises video or audio output from the jobsite.

7. A method for improving a building information modeling system for a construction project, comprising:
coupling a field reporting functionality to the building modeling system;
the field reporting functionality configured to:
obtain virtual project data relating to the building modeling system, wherein project data is associated with resolution of a task of the building modeling system, and wherein project data includes at least one asset required for the associated resolution, wherein each asset comprises geometric data and location data, wherein geometric and location data is defined by the information modeling system;
provide a schedule modality configured to a first timeline for both a delivery of the project data and a second timeline for an associated resolution to the project data, wherein field data comprises video, audio and textual output linked to the first or second timeline; and
provide a progress modality configured to link field data from a jobsite of the construction project to the project data; and
providing a meeting functionality configured to generate communication data linked to the first or second timeline, wherein communication data comprises video or audio output from the jobsite.
